(19) United States
(12) Patent Application Publication
(10) Pub. No.: US 2026/0351840 A1
(43) Pub. Date: Nov. 5, 2026

(54) ANTENNA AND ANTENNA DEVICE

(71) Applicant: YOKOWO CO., LTD., Tokyo (JP)

(72) Inventors: Noritaka TERASHITA, Tomioka-Shi, Gunma (JP); Motohisa ONO, Tomioka-Shi, Gunma (JP); Kazusa KANOU, Tomioka-Shi, Gunma (JP)

(73) Assignee: YOKOWO CO., LTD., Tokyo (JP)

(21) Appl. No.: 19/488,585

(22) PCT Filed: May 22, 2024
(86) PCT No.: PCT/JP2024/018866

§ 371 Date: Nov. 26, 2025

(30) Foreign Application Priority Data
May 30, 2023 (JP) 2023-088304

(51) Int. Cl. H01Q 1/32; H01Q 9/36

(52) U.S. Cl. CPC H01Q 1/3275; H01Q 9/36

(57) ABSTRACT

An antenna that supports a Digital Audio Broadcasting (DAB) frequency band, the antenna includes: a first capacitively loaded element; a first coil having one end connected to the first capacitively loaded element; a second coil having one end connected to another end of the first coil, and another end connected to a feeding portion; and a third coil having one end connected to the other end of the first coil, and another end connected to a ground portion.

### TECHNICAL FIELD

The present disclosure relates to an antenna and an antenna device.

### BACKGROUND ART

In recent years, various antenna devices to be mounted to vehicles have been developed. For example, the antenna device described in PTL 1 is arranged at the roof of a vehicle.

### CITATION LIST

### Patent Literature

[PTL 1] Japanese Patent Application Publication No. 2012-161075

### SUMMARY OF INVENTION

### Technical Problem

For example, in the antenna device described in PTL 1, two types of helical portions are arranged at a fixed interval in the direction of height: a first helical portion closer to a base portion and a second helical portion distant from the base portion. In the antenna device of PTL 1, particularly when the second helical portion is formed of a plate-shaped conductive member, a structure is such that the plate-shaped second helical portion stands at an antenna base, which limits reduction in profile.

The present disclosure is directed to reduction in the profiles of an antenna and an antenna device including the antenna, thereby suppressing a reduction in the gain of the antenna. The present disclosure is directed also to other which will become apparent from the description of this specification.

### Solution to Problem

An aspect of the present disclosure is an antenna that supports a Digital Audio Broadcasting (DAB) frequency band, the antenna comprising: a first capacitively loaded element; a first coil having one end connected to the first capacitively loaded element; a second coil having one end connected to another end of the first coil, and another end connected to a feeding portion; and a third coil having one end connected to the other end of the first coil, and another end connected to a ground portion.

Another aspect of the present disclosure is an antenna that supports a Frequency Modulation (FM) frequency band, the antenna comprising: a second capacitively loaded element; a fourth coil having one end connected to the second capacitively loaded element, and another end connected to a feeding portion; and a fifth coil having one end connected to the second capacitively loaded element, and another end connected to a ground portion.

Still another aspect of the present disclosure is an antenna device that supports a Digital Audio Broadcasting (DAB) frequency band and a Frequency Modulation (FM) frequency band, the antenna comprising: a base; a first capacitively loaded element and a second capacitively loaded element that face the base; a first coil, a second coil, and a third coil that are arranged between the base and the first capacitively loaded element; and a fourth coil and a fifth coil that are arranged between the base and the second capacitively loaded element, wherein the first coil has one end connected to the first capacitively loaded element, the second coil has one end connected to another end of the first coil, and another end connected to a feeding portion, the third coil has one end connected to the other end of the first coil, and another end connected to a ground portion, the fourth coil has one end connected to the second capacitively loaded element, and another end connected to a feeding portion, and the fifth coil has one end connected to the second capacitively loaded element, and another end connected to the ground portion.

According to aspects described above of the present disclosure, an antenna and an antenna device including the antenna can achieve reduction in profile, thereby suppressing a reduction in the gain of the antenna.

### BRIEF DESCRIPTION OF DRAWINGS

FIG. 1 is a top view of an antenna device according to an embodiment.

FIG. 2 is an exploded perspective view of a base, a case, an AM antenna, an FM antenna, and a DAB antenna according to an embodiment.

FIG. 3 is a perspective view illustrating details of a DAB antenna according to an embodiment.

FIG. 4 is a diagram illustrating an example of a DAB antenna having an inverted-F antenna structure.

FIG. 5 is a diagram illustrating an example of an FM antenna having a tip short antenna structure.

FIG. 6 is a diagram illustrating an example of a DAB antenna having an inverted-L antenna structure.

FIG. 7 is a graph illustrating the frequency characteristics of VSWRs in an FM frequency band and its adjacent bands of an antenna having an inverted-L antenna structure and an antenna having a tip short antenna structure.

FIG. 8 is a graph illustrating the frequency characteristics of VSWRs in a DAB frequency band and its adjacent bands of an antenna having a tip short antenna structure and an antenna having an inverted-F antenna structure.

FIG. 9 is a perspective view of an antenna device according to a comparative example.

FIG. 10 is a graph illustrating the frequency characteristics of the sensitivity in a DAB frequency band of a DAB antenna according to an embodiment of the present disclosure and an antenna device according to a comparative example.

FIG. 11 is a graph illustrating the frequency characteristics of the sensitivity in an FM frequency band of an FM antenna according to an embodiment of the present disclosure and an antenna device according to a comparative example.

FIG. 12 is a diagram schematically illustrating a DAB feeding portion and a DAB short circuit portion of a DAB antenna according to one example of an embodiment of the present disclosure.

FIG. 13 is a diagram schematically illustrating a DAB feeding portion and a DAB short circuit portion of a DAB antenna according to another example of an embodiment of the present disclosure.

FIG. 14 is a circuit diagram illustrating a first example of the configuration from an AM antenna and an FM antenna to a receiver.

FIG. 15 is a graph illustrating the frequency characteristics of the sensitivity in an FM frequency band of FM antennas and AM antennas according to AM/FM Structure Example 1, AM/FM Structure Example 2, and AM/FM Structure Example 3.

FIG. 16 is a circuit diagram illustrating a second example of the configuration from an AM antenna and an FM antenna to a receiver.

FIG. 17 is a circuit diagram illustrating a third example of the configuration from an AM antenna and an FM antenna to a receiver.

FIG. 18 is a circuit diagram illustrating a fourth example of the configuration from an AM antenna and an FM antenna to a receiver.

FIG. 19 is a top view of an AM antenna and an FM antenna illustrated in FIG. 18.

FIG. 20 is a perspective view of an antenna device according to a first modified example of an embodiment of the present disclosure.

FIG. 21 is an exploded perspective view of an antenna device according to a first modified example of an embodiment of the present disclosure.

FIG. 22 is a side view of an antenna device according to a first modified example of an embodiment of the present disclosure, with a case portion and screws removed.

FIG. 23 is a perspective view of an antenna device according to a second modified example of an embodiment of the present disclosure.

FIG. 24 is an exploded perspective view of an antenna device according to a second modified example of an embodiment of the present disclosure.

FIG. 25 is a side view of an antenna device according to a second modified example of an embodiment of the present disclosure, with a case portion and screws removed.

FIG. 26 is an exploded perspective view of an antenna device according to a third modified example of an embodiment of the present disclosure.

FIG. 27 is an explanatory diagram illustrating a cross section of a part of the configuration of an antenna device according to a third modified example.

FIG. 28 is an explanatory diagram of an antenna device according to a fourth modified example of an embodiment of the present disclosure.

FIG. 29 is an explanatory diagram of an antenna device according to a fifth modified example of an embodiment of the present disclosure.

### DESCRIPTION OF EMBODIMENTS

Hereinafter, embodiments of the present disclosure will be described with reference to the drawings. In all the drawings, components that are the same or similar are given the same reference signs and descriptions thereof are omitted as appropriate.

In the present specification, ordinal numbers such as “first,” “second”, “third”, and the like are given merely to distinguish between similarly named structures, unless otherwise specified, and do not refer to any particular characteristics (e.g., order or importance) of the structures.

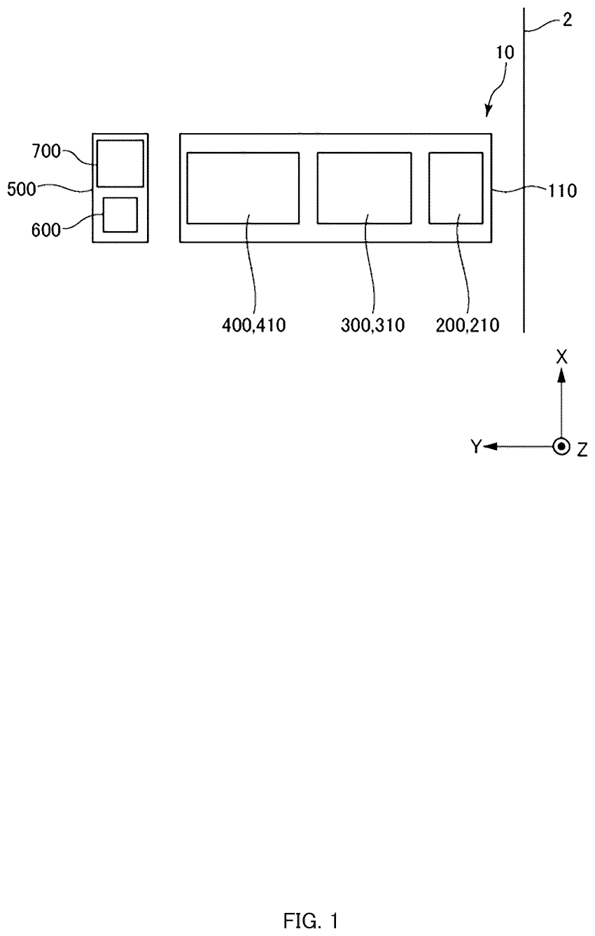

FIG. 1 is a top view of an antenna device 10 according to an embodiment.

In FIG. 1 and subsequent figures, an arrow indicating a first direction X, a second direction Y, or a third direction Z indicates that the direction from the base end to the tip end of the arrow is the positive direction of the direction indicated by the arrow, and that the direction from the tip end to the base end of the arrow is the negative direction of the direction indicated by the arrow. In FIG. 1 and the subsequent figures, a white circle with a black dot representing the first direction X, the second direction Y, or the third direction Z indicates that the direction from the rear of the paper to the front is the positive direction of the direction indicated by the white circle with the black dot, and that the direction from the front to the rear of the paper is the negative direction of the direction indicated by the white circle with the black dot. In FIG. 1 and the subsequent figures, a white circle with an X representing the first direction X, the second direction Y, or the third direction Z indicates that the direction from the front to the rear of the paper is the positive direction of the direction indicated by the white circle with the X, and that the direction from the rear to the front of the paper is the negative direction of the direction indicated by the white circle with the X.

In FIG. 1, the antenna device 10 is mounted at a roof 2 of a vehicle (not illustrated). The first direction X is a front-rear direction as seen from a driver's seat of the vehicle. The positive direction of the first direction X is the direction from the rear to the front as seen from the driver's seat of the vehicle. The negative direction of the first direction X is the direction from the front to the rear as seen from the driver's seat of the vehicle. The second direction Y is orthogonal to the first direction X. The second direction Y is a left-right direction as seen from the driver's seat of the vehicle. The positive direction of the second direction Y is the direction from the right to the left as seen from the driver's seat of the vehicle. The negative direction of the second direction Y is the direction from the left to the right as seen from the driver's seat of the vehicle. The second direction Y is the width direction of the vehicle as well. The third direction Z is orthogonal to both the first direction X and the second direction Y. The third direction Z is an up-down direction as seen from the driver's seat of the vehicle. The positive direction of the third direction Z is the direction from below to the above when seen from the driver's seat of the vehicle. The negative direction of the third direction Z is a direction from above to below when seen from the driver's seat of the vehicle. The same applies to figures subsequent to FIG. 1.

Hereinafter, the direction perpendicular to the third direction Z will be referred to as XY plane direction, as needed. Hereinafter, a surface perpendicular to the vertical direction will be referred to as a horizontal plane, as needed. The third direction Z of the roof 2 may be inclined with respect to the vertical direction. For example, when the roof 2 is located on the rear side of the roof of the vehicle, this rear side is not parallel to the horizontal plane. In other words, since the surface of the roof 2 at which the antenna is placed is not parallel to the horizontal plane, the third direction Z of the roof 2 may be a direction displaced from the vertical direction (inclined relative to the vertical direction).

The antenna device 10 in an embodiment of the present disclosure includes a base 110, an Amplitude Modulation (AM) antenna 200, a Frequency Modulation (FM) antenna 300, a Digital Audio Broadcasting (DAB) antenna 400, a ground element 500, a Vehicle to Everything (V2X) antenna 600, and a Global Navigation Satellite System (GNSS) antenna 700. The antenna device 10 may include a communication antenna such as a Telephone (TEL) antenna and/or a Wi-Fi (registered trademark) antenna, in place of or in addition to the V2X antenna 600. The AM antenna 200 includes an AM capacitively loaded element 210. The FM antenna 300 includes an FM capacitively loaded element 310. The DAB antenna 400 includes a DAB capacitively loaded element 410.

The base 110, the AM antenna 200, the FM antenna 300, the DAB antenna 400, the ground element 500, the V2X antenna 600 and the GNSS antenna 700 (hereinafter, respective antennas of the AM antenna 200, the FM antenna 300, the DAB antenna 400, the V2X antenna 600 and the GNSS antenna 700 may be collectively referred to as “respective antennas”) are arranged on the upper side of the roof 2 (at the top surface of the roof 2) or on the lower side of the roof 2 (on the inner side of the vehicle)

Here, the antenna device 10 (respective antennas) is not limited to being attached to a vehicle, but may also be brought into a vehicle and used within the vehicle. Further, it is assumed that the antenna device 10 according to an embodiment of the present disclosure (respective antennas) is used for a “vehicle” that is a wheeled vehicle, however, it is not limited thereto and, for example, the antenna device 10 may be used for, for example, a flight vehicle such as a drone and the like, a probe vehicle, and an unwheeled movable body such as construction machinery, agricultural machinery, a vessel, and the like. Furthermore, the antenna device 10 (respective antennas) may be an antenna device (respective antennas) used for those other than mobile bodies.

For example, when the respective antennas are arranged on the lower side of the roof 2, the respective antennas are not seen from the outside of the vehicle. In this case, restrictions on vehicle design are reduced, and the degree of freedom in vehicle design is increased. Further, the aerodynamic effects of the respective antennas can be suppressed, and furthermore, the respective antennas can be made less susceptible to the noise from the vehicle. However, the respective antennas may be incorporated into an exterior part such as a spoiler or the like. In this case, the respective antennas only have to be configured to be shielded from the noise affected by the vehicle.

The AM antenna 200, the FM antenna 300, and the DAB antenna 400 are arranged on the top surface side of the base 110 in the positive direction of the third direction Z. When seen from the third direction Z, the base 110 has a substantially rectangular shape having a pair of short sides substantially parallel to the first direction X and a pair of long sides substantially parallel to the second direction Y. However, the shape of the base 110 is not limited to this example. When seen from the third direction Z, the base 110, the AM antenna 200, the FM antenna 300, and the DAB antenna 400 are arranged on the negative direction side of the second direction Y with respect to the center of the roof 2 in the second direction Y (width direction of the vehicle). When seen from the third direction Z, the AM antenna 200, the FM antenna 300, and the DAB antenna 400 are arranged substantially parallel to the second direction Y. Specifically, when seen from the third direction Z, the FM antenna 300 is arranged between the AM antenna 200 and the DAB antenna 400 in the second direction Y. When seen from the third direction Z, the AM antenna 200 is arranged on the right side, in the negative direction of the second direction Y, with respect to the FM antenna 300. When seen from the third direction Z, the DAB antenna 400 is arranged on the left side, in the positive direction of the second direction Y, with respect to the FM antenna 300. However, the arrangement of the AM antenna 200, the FM antenna 300, and the DAB antenna 400 is not limited to this example. The AM antenna 200 illustrated in FIG. 1 is arranged at a position close to the end part on the negative direction side of the second direction Y of the roof 2 of the vehicle.

When seen from the third direction Z, the AM capacitively loaded element 210 has a substantially rectangular shape with a pair of long sides substantially parallel to the first direction X and a pair of short sides substantially parallel to the second direction Y. However, the shape of the AM capacitively loaded element 210 is not limited to this example. The AM capacitively loaded element 210 can have various shapes such as a strip, a circle, a polygon, a three-dimensional structure, a meander, and the like. The AM capacitively loaded element 210 may have a shape to reduce interference with another antenna (other antennas) arranged in the vicinity of the AM capacitively loaded element 210. For example, the AM capacitively loaded element 210 may have a slot, a slit, and/or an opening formed therein. Alternatively, the AM capacitively loaded element 210 may extend in a meandering manner. The AM capacitively loaded element 210 may have a structure to control the gain or directivity of another antenna arranged in the vicinity of the AM capacitively loaded element 210. For example, the AM capacitively loaded element 210 may act as a reflector or director for another antenna.

When seen from the third direction Z, the FM capacitively loaded element 310 has a substantially rectangular shape with a pair of short sides substantially parallel to the first direction X and a pair of long sides substantially parallel to the second direction Y. However, the shape of the FM capacitively loaded element 310 is not limited to this example. Similarly to the description of the shape of the AM capacitively loaded element 210, the FM capacitively loaded element 310 can also adopt various shapes.

When seen from the third direction Z, the DAB capacitively loaded element 410 has a substantially rectangular shape with a pair of short sides substantially parallel to the first direction X and a pair of long sides substantially parallel to the second direction Y. However, the shape of the DAB capacitively loaded element 410 is not limited to this example. Similarly to the description of the shape of the AM capacitively loaded element 210, the DAB capacitively loaded element 410 can also adopt various shapes.

When seen from the third direction Z, one right side of the FM capacitively loaded element 310 in the negative direction of the second direction Y and one left side of the AM capacitively loaded element 210 in the positive direction of the second direction Y face each other in the second direction Y. When seen from the third direction Z, one side of the FM capacitively loaded element 310 on the positive direction side of the second direction Y and one side of the DAB capacitively loaded element 410 on the negative direction side of the second direction Y face each other in the second direction Y.

When seen from the third direction Z, the ground element 500, the V2X antenna 600, and the GNSS antenna 700 are arranged closer to substantially the center of the roof 2 in the second direction Y (width direction of the vehicle). The V2X antenna 600 and the GNSS antenna 700 are arranged on the top surface side of the ground element 500 in the positive direction of the third direction Z. When seen from the third direction Z, the V2X antenna 600 and the GNSS antenna 700 are arranged substantially parallel to the first direction X. In specific, when seen from the third direction Z, the V2X antenna 600 is arranged on the negative direction side of the first direction X with respect to the GNSS antenna 700. When seen from the third direction Z, the GNSS antenna 700 is arranged on the positive direction side of the first direction X with respect to the V2X antenna 600. However, the arrangement of the V2X antenna 600 and the GNSS antenna 700 is not limited to this example.

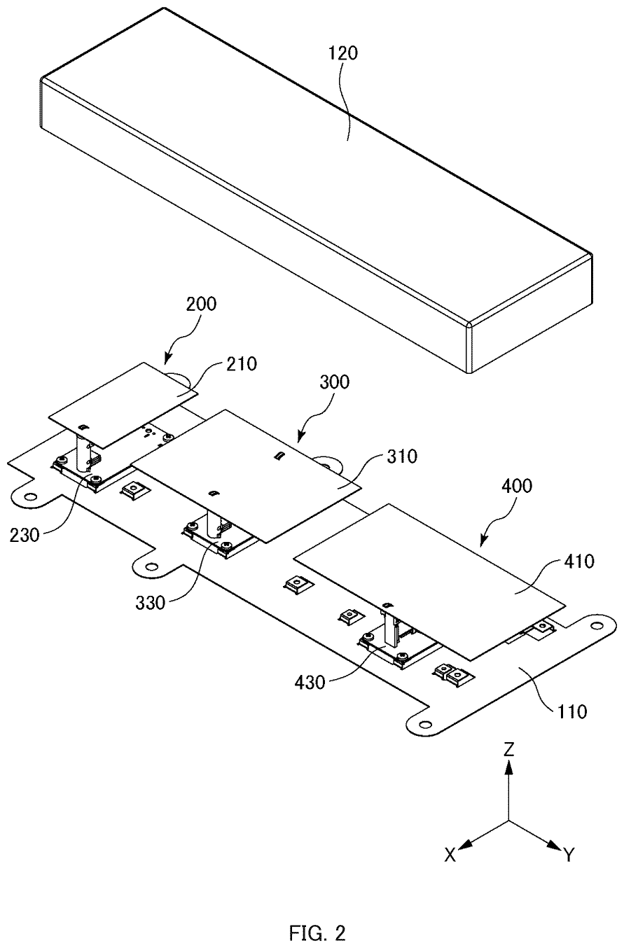

FIG. 2 is an exploded perspective view of the base 110, the case 120, the AM antenna 200, the FM antenna 300, and the DAB antenna 400 according to an embodiment.

The base 110 is electrically connectable to the metal part of the roof 2 illustrated in FIG. 1. For example, the base 110 may be directly connected to the roof 2. Alternatively, the base 110 may be electrically connected to the roof 2 through another conductor such as a conductive plate, conductive sheet, or the like. When the base 110 is directly connected to the roof 2, conductor loss can be reduced and grounding performance can be improved, as compared to when the base 110 is electrically connected to the roof 2 through another conductor.

In an embodiment of the present disclosure, the roof 2 and the base 110 act as ground. Hereinafter, the roof 2; the base 110; and a member that is electrically connected to the roof 2 or the base 110 to act as ground in the same manner as the roof 2 and the base 110, may be referred to as “ground portion”. As described above, when the base 110 is electrically connected to the roof 2 through another conductor, the base 110, the roof 2, and the other conductor result in the ground portion.

The base 110 may be electrically connected to the roof 2 through a filter member. Examples of the filter member include a filter circuit, a filter pattern, an electronic component having a filtering function, and combinations thereof. With the filter member being arranged, it is possible to ensure isolation between the antenna mounted at the base 110 and the antenna arranged outside the base 110. This makes it possible to suppress interference between these antennas. Further, it is possible to prevent noise from entering the antenna mounted at the base 110.

The base 110 may be electrically connected to the roof 2 by capacitive coupling. For example, in the relatively high frequency antenna, the roof 2 and the base 110 can act as ground even when the base 110 is electrically connected to the roof 2 by capacitive coupling. When the base 110 is electrically connected to the roof 2 by capacitive coupling, the base 110 can be connected to the roof 2 by, for example, a technique of joining resins or non-ferrous metals, without connecting the base 110 to the roof by screwing, welding, or the like. Accordingly, the base 110 can be connected to the roof 2 at low cost, as compared with the case where the base 110 is connected to the roof 2 by welding.

An AM amplifier substrate 230, an FM amplifier substrate 330, and a DAB amplifier substrate 430 are arranged on the top surface side of the base 110 in the positive direction of the third direction Z. The AM capacitively loaded element 210 is arranged at a position spaced apart from and above, on the positive direction side of the third direction Z, the top surface of the AM amplifier substrate 230 on the positive direction side of the third direction Z. The FM capacitively loaded element 310 is arranged at a position spaced apart from and above, on the positive direction side of the third direction Z, the top surface of the FM amplifier substrate 330 on the positive direction side of the third direction Z. The DAB capacitively loaded element 410 is arranged at a position spaced apart from and above, on the positive direction side of the third direction Z, the top surface of the DAB amplifier substrate 430 on the positive direction side of the third direction Z.

The case 120 is made of a resin having radio wave transparency, or the like, and has a substantially rectangular parallelepiped shape. However, the shape of the case 120 is not limited to this example. The case 120 covers the base 110, the AM antenna 200, the FM antenna 300, and the DAB antenna 400 from above on the positive direction side of the third direction Z. The case 120 forms a predetermined accommodation space with the base 110. The AM antenna 200, the FM antenna 300, and the DAB antenna 400 are accommodated inside the accommodation space. The case 120 may be mounted to the base 110 through an elastomeric surrounding body such as an O-ring, a pad or the like. Incorporation of the elastic surrounding body makes it possible to achieve waterproofing or dustproofing of the accommodation space. In FIG. 1, the case 120 is omitted.

The AM antenna 200, the FM antenna 300, and the DAB antenna 400 according to an embodiment of the present disclosure are arranged at the roof 2 illustrated in FIG. 1, for example. In an embodiment of the present disclosure, when the respective antennas are arranged in the space above on the positive direction side of the third direction Z of the roof 2, the respective antennas have lower heights in the third direction Z as compared with the antenna device described in PTL 1, for example. In this case, the gains of the respective antennas may decrease due to a reduction in the radiation resistances of the respective antennas caused by reduction in the profiles of the respective antennas. Thus, in an embodiment of the present disclosure, the size in the direction of the XY plane of each of the AM capacitively loaded element 210, the FM capacitively loaded element 310, and the DAB capacitively loaded element 410 is increased, thereby improving the gain, bandwidth, and antenna efficiency of each of the AM antenna 200, the FM antenna 300, and the DAB antenna 400.

It is preferable that the height of each of the AM antenna 200, the FM antenna 300, and the DAB antenna 400 in the third direction Z is as high as possible in the third direction Z within a range without impeding the improvement of the gain, bandwidth, and antenna efficiency of each of the antennas. For example, when each of the AM antenna 200, the FM antenna 300, and the DAB antenna 400 is arranged on the lower side of the roof 2 (on the inner side of the vehicle), the height of each of antennas in the third direction Z may be 80% or more and 90% or less of the depth in the third direction Z. In one example, when the depth on the lower side of the roof 2 in the third direction Z from the roof 2 is 35 mm, the height in the third direction Z of each of the AM antenna 200, the FM antenna 300 and the DAB antenna 400 may be set to 30 mm. The AM antenna 200, the FM antenna 300 and the DAB antenna 400 are arranged along the surface of the roof 2. With the respective antennas being arranged along the surface of the roof 2, the heights of the respective antennas in the third direction Z can be increased within a range in which the improvements in the respective gains, bandwidths, and antenna efficiencies thereof are not impeded. With the heights of the respective antennas in the third direction Z being increased, it is possible to improve the gains of the respective antennas.

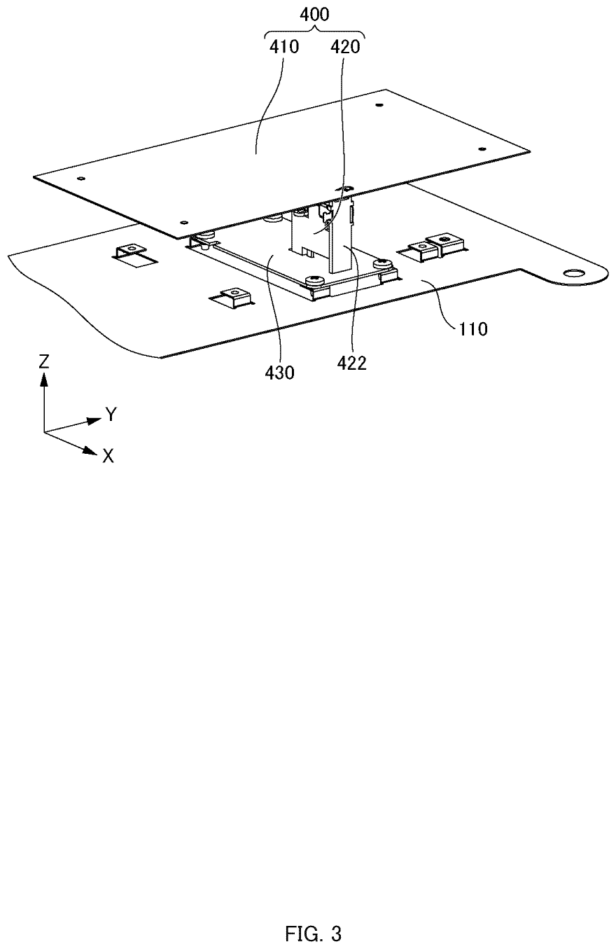

FIG. 3 is a perspective view illustrating the details of the DAB antenna 400 according to an embodiment.

The DAB antenna 400 includes a DAB helical element 420 in addition to the DAB capacitively loaded element 410. The DAB capacitively loaded element 410 is electrically connected to a DAB amplifier substrate 430 through the DAB helical element 420. The DAB capacitively loaded element 410 is held at a position spaced apart from and above, on the positive direction side of the third direction Z, the top surface of the DAB amplifier substrate 430 on the positive direction side of the third direction Z. Specifically, the DAB helical element 420 is held by a holder 422 made of resin and/or the like. Accordingly, the DAB helical element 420 is arranged so as to extend in the positive direction of the third direction Z from the DAB amplifier substrate 430. The end part of the DAB helical element 420 on the positive direction side of the third direction Z is connected to the DAB capacitively loaded element 410. Thus, the DAB capacitively loaded element 410 is held at a position spaced apart from and above, on the positive direction side of the third direction Z, the top surface of the DAB amplifier substrate 430 on the positive direction side of the third direction Z. The matters described about the DAB antenna 400 with reference to FIG. 3 can similarly apply to the AM antenna 200 and the FM antenna 300.

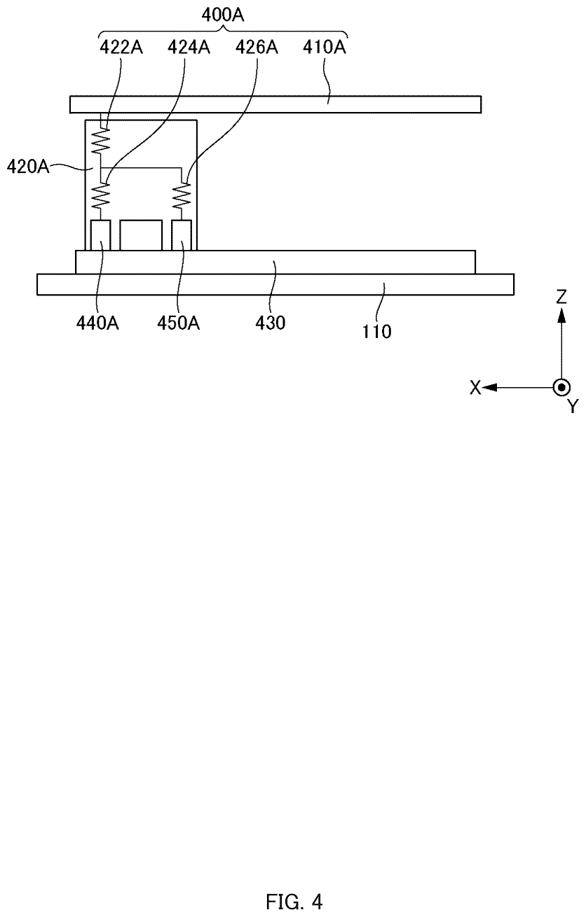

FIG. 4 is a diagram illustrating an example of a DAB antenna 400A having an inverted-F antenna structure. The matters described about the inverted-F antenna structure of the DAB antenna 400A with reference to FIG. 4 can similarly apply to the AM antenna 200 and the FM antenna 300.

The DAB antenna 400A includes a DAB capacitively loaded element 410A, an upper coil 422A, a feeding-side lower coil 424A, and a short-circuit-side lower coil 426A. The upper coil 422A, the feeding-side lower coil 424A and the short-circuit-side lower coil 426A are arranged at the DAB antenna substrate 420A. The inductance of the upper coil 422A is, for example, 0.003 μH. The inductance of the feeding-side lower coil 424A is, for example, 0.050 μH. The inductance of the short-circuit-side lower coil 426A is, for example, 0.066 μH. The DAB antenna substrate 420A is set up substantially perpendicular to the top surface of the DAB amplifier substrate 430 on the positive direction side of the third direction Z. The DAB antenna substrate 420A, the upper coil 422A, the feeding-side lower coil 424A and the short-circuit-side lower coil 426A of the inverted-F antenna structure correspond to the DAB helical element 420 illustrated in FIG. 3.

The DAB antenna substrate 420A is wired, using the feeding line, between the upper coil 422A and the feeding-side lower coil 424A. The upper end of the upper coil 422A on the positive direction side of the third direction Z is electrically connected to the end part of the DAB capacitively loaded element 410A on the positive direction side of the first direction X. The upper end of the feeding-side lower coil 424A on the positive direction side of the third direction Z is electrically connected to the lower end of the upper coil 422A on the negative direction side of the third direction Z. The lower end of the feeding-side lower coil 424A on the negative direction side of the third direction Z is electrically connected to a DAB feeding portion 440A arranged at the DAB amplifier substrate 430. The feeding line arranged at the DAB antenna substrate 420A is a conductor that electrically connects the DAB capacitively loaded element 410A and the DAB amplifier substrate 430, and connects the upper coil 422A and the feeding-side lower coil 424A in series. In the DAB antenna substrate 420A, the short-circuit-side lower coil 426A is wired between the upper coil 422A and the feeding-side lower coil 424A using a short-circuit line that is a conductor branching from the feeding line. Accordingly, the upper end of the short-circuit-side lower coil 426A on the positive direction side of the third direction Z is electrically connected between the lower end of the upper coil 422A on the negative direction side of the third direction Z and the upper end of the feeding-side lower coil 424A on the positive direction side of the third direction Z. The lower end of the short-circuit-side lower coil 426A on the negative direction side of the third direction Z is electrically connected to a DAB short-circuit portion 450A arranged at the DAB amplifier substrate 430. The DAB short circuit portion 450A is electrically connected to the ground portion (base 110) through the DAB amplifier substrate 430.

In the inverted-F antenna structure, the impedance of the DAB antenna 400A can be adjusted by adjusting the upper coil 422A, the feeding-side lower coil 424A, and the short-circuit-side lower coil 426A without changing the size of the DAB capacitively loaded element 410A in the directions of the XY plane. For example, at the DAB amplifier substrate 430, the impedance matching circuit may be arranged between the DAB antenna 400A and a DAB amplifier. The impedance of the DAB amplifier is determined by the semiconductor used for the DAB amplifier. Thus, if the impedance matching circuit becomes complex according to the impedance of the DAB amplifier, the loss of the impedance matching circuit will increase. In contrast, when the inverted-F antenna structure is used, the impedance of the DAB antenna 400A can be adjusted with the upper coil 422A, the feeding-side lower coil 424A, and the short-circuit-side lower coil 426A. Accordingly, it is possible to increase the degree of freedom in designing the DAB antenna 400A and the DAB amplifier substrate 430.

In order to suppress interference with other receiving antennas such as the AM antenna 200, the FM antenna 300, and the like, it is preferable that the DAB capacitively loaded element 410, the feeding-side lower coil 424A, and the short-circuit-side lower coil 426A are arranged so as to be electrically isolated from other receiving antennas.

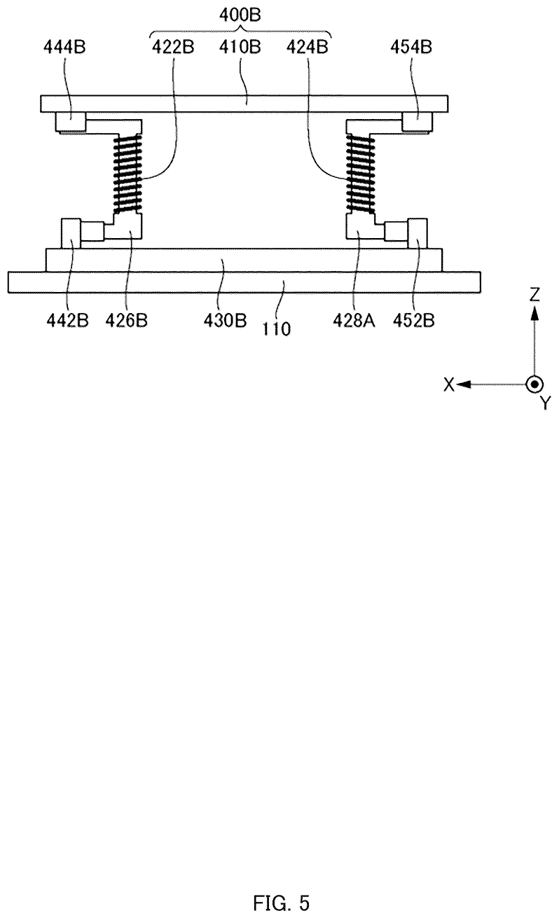

FIG. 5 is a diagram illustrating an example of an FM antenna 400B having a tip short antenna structure. The matters described about the tip short antenna structure of the FM antenna 400B with reference to FIG. 5 can similarly apply to the AM antenna 200 and the DAB antenna 400.

The FM antenna 400B includes an FM capacitively loaded element 410B, a feeding-side coil 422B, and a short-circuit-side coil 424B.

The feeding-side coil 422B is formed by winding onto the feeding-side bobbin 426B. The lower end of the feeding-side coil 422B on the negative direction side of the third direction Z is electrically connected to an FM feeding portion 442B arranged at an FM amplifier substrate 430B. The upper end of the feeding-side coil 422B on the positive direction side of the third direction Z is electrically connected to a feeding-side connection portion 444B arranged at the end part of the FM capacitively loaded element 410B on the positive direction side of the first direction X.

The short-circuit-side coil 424B is formed by winding onto the short-circuit-side bobbin 428B. The lower end of the short-circuit-side coil 424B on the negative direction side of the third direction Z is electrically connected to an FM short-circuit portion 452B arranged at the FM amplifier substrate 430B. The FM short-circuit portion 452B is electrically connected to the ground portion (base 110) through the FM amplifier substrate 430B. The upper end of the short-circuit-side coil 424B on the positive direction side of the third direction Z is electrically connected to a short-circuit-side connection portion 454B arranged at the end part of the FM capacitively loaded element 410B on the negative direction side of the first direction X. The inductance of the short-circuit-side coil 424B is substantially the same as the inductance of the feeding-side coil 422B. For example, the difference between the inductance of the feeding-side coil 422B and the inductance of the short-circuit-side coil 424B is 0.02 μH or less.

In the example illustrated in FIG. 5, the feeding-side coil 422B is located on the inner side of the FM capacitively loaded element 410B in the negative direction of the first direction X with respect to the FM feeding portion 442B and the feeding-side connection portion 444B, in the first direction X. Further, the short-circuit-side coil 424B is located on the inner side of the FM capacitively loaded element 410B in the positive direction of the first direction X with respect to the FM short-circuit portion 452B and the short-circuit-side connection portion 454B, in the first direction X. Accordingly, as compared with the case where the feeding-side coil 422B is aligned with the FM feeding portion 442B and the feeding-side connection portion 444B with respect to the first direction X, or the case where the short-circuit-side coil 424B is aligned with the FM short-circuit portion 452B and the short-circuit-side connection portion 454B with respect to the first direction X, when the feeding-side coil 422B and the short-circuit-side coil 424B are arranged on the lower side of the roof 2 (on the inner side of the vehicle), for example, they can be separated from the metallic inner wall of the vehicle, and interference between the coils and the inner wall can be suppressed. This can improve the performance of the FM antenna 400B as compared with the above-described case. Further, even if the FM antenna 400B is reduced in the size in the directions of the XY plane, the performance of the FM antenna 400B can be maintained, as compared with the above-described case. The short-circuit-side coil 424B is arranged at a distance from the center of the FM capacitively loaded element 410B on the side opposite to the side on which the feeding-side coil 422B is arranged.

In the example illustrated in FIG. 5, the lower end of the feeding-side coil 422B on the negative direction side of the third direction Z is located at the predetermined position in the FM amplifier substrate 430B (hereinafter, may be referred to as “first position”). Further, the lower end of the short-circuit-side coil 424B on the negative direction side of the third direction Z is located at another predetermined position in the FM amplifier substrate 430B (hereinafter, may be referred to as “second position”). As described above, when seen from the third direction Z, the FM capacitively loaded element 410B has a substantially rectangular shape with a pair of short sides substantially parallel to the first direction X and a pair of long sides substantially parallel to the second direction Y. That is, the FM capacitively loaded element 410B is formed such that the length in the second direction Y intersecting the first direction X is longer than the length in the first direction X, in a top view. In this case, the first position and the second position are located to be aligned in the first direction X at the FM amplifier substrate 430B.

In order to suppress interference with other receiving antennas such as the AM antenna 200, the DAB antenna 400, and the like, it is preferable that the FM capacitively loaded element 410B, the feeding-side coil 422B, and the short-circuit-side coil 424B are arranged so as to be electrically isolated from other receiving antennas.

When the operating frequency of the FM antenna 400B is relatively high, the FM capacitively loaded element 410B may be electrically connected to the FM amplifier substrate 430B through a connecting conductor, such as a connection line, a connecting plate, or the like, instead of the feeding-side coil 422B and the short-circuit-side coil 424B.

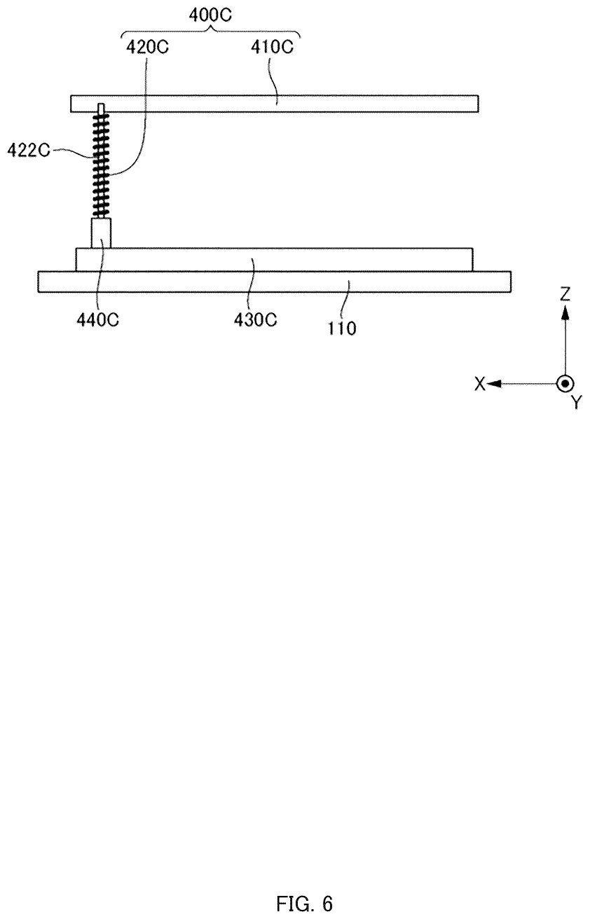

FIG. 6 is a diagram illustrating an example of a DAB antenna 400C having an inverted-L antenna structure. The matters described about the inverted-L antenna structure of the DAB antenna 400C with reference to FIG. 6 can similarly apply to the AM antenna 200 and the FM antenna 300. The AM antenna 200 does not have to include the coil corresponding to the DAB coil 420C, which will be described later, as an antenna system that does not resonate.

The DAB antenna 400C includes a DAB capacitively loaded element 410C and a DAB coil 420C. The DAB coil 420C is formed by winding onto a DAB bobbin 422C. The lower end of the DAB coil 420C on the negative direction side of the third direction Z is electrically connected to a DAB feeding portion 440C arranged at the DAB amplifier substrate 430. The upper end of the DAB coil 420C on the positive direction side of the third direction is electrically connected to the end part of the DAB capacitively loaded element 410C on the positive direction side of the first direction X.

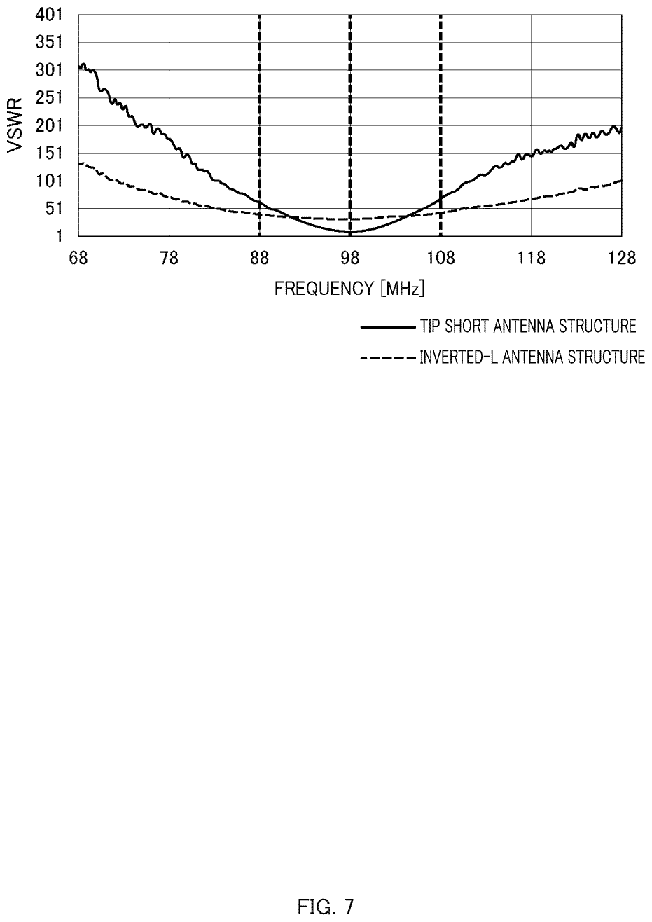

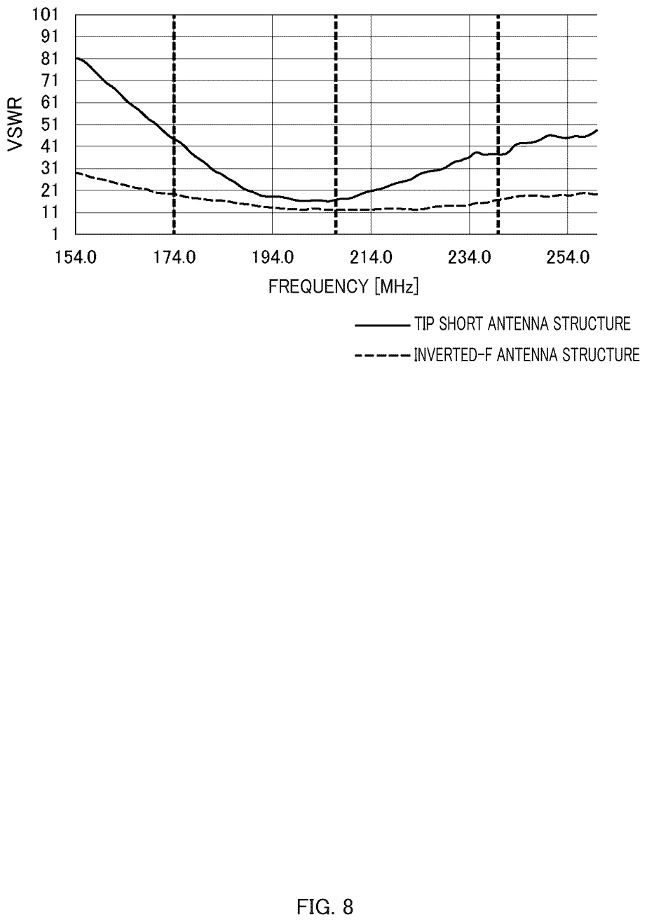

FIG. 7 is a graph illustrating the frequency characteristics of voltage standing wave ratios (VSWRs) in the FM frequency band and its adjacent bands of the antenna having the inverted-L antenna structure and the antenna having the tip short antenna structure. FIG. 8 is a graph illustrating the frequency characteristics of VSWRs in the DAB frequency band and its adjacent bands of the antenna having the tip short antenna structure and the antenna having the inverted-F antenna structure.

The horizontal axis of the graphs illustrated in FIGS. 7 and 8 represents frequency (unit: MHz). The vertical axis of the graphs illustrated in FIGS. 7 and 8 represents VSWR. Of three dashed lines drawn parallel to the vertical axis of the graph illustrated in FIG. 7, two dashed lines at both ends indicate that the FM frequency band is in a range between the two dashed lines. Of the three dashed lines drawn parallel to the vertical axis of the graph illustrated in FIG. 7, the central dashed line indicates the center frequency in the FM frequency band. Of three dashed lines drawn parallel to the vertical axis of the graph illustrated in FIG. 8, two dashed lines at both ends indicate that the DAB frequency band is in a range between the two dashed lines. Of the three dashed lines drawn parallel to the vertical axis of the graph illustrated in FIG. 8, the central dashed line indicates the center frequency in the DAB frequency band.

As illustrated in FIG. 7, the VSWR of the tip short antenna structure is lower than the VSWR of the inverted-L antenna structure over substantially the entire FM frequency band. Accordingly, in the FM frequency band, the tip short antenna structure is preferable to the inverted-L antenna structure.

As illustrated in FIG. 8, the VSWR of the inverted-F antenna structure is lower than the VSWR of the tip short antenna structure over the entire DAB frequency band. Further, the deviation of the VSWR of the inverted-F antenna structure in the DAB frequency band is lower than the deviation of the VSWR of the tip short antenna structure in the DAB frequency band. Accordingly, in the DAB frequency band, the inverted-F antenna structure is preferable to the tip short antenna structure.

Each of the AM antenna 200, the FM antenna 300 and the DAB antenna 400 can have, for example, the inverted-F antenna structure, the tip short antenna structure, or the inverted-L antenna structure, depending on the condition needed for each of the antennas. For example, when the AM antenna 200, the FM antenna 300, and the DAB antenna 400 are arranged on the lower side of the roof 2 (on the inner side of the vehicle), they are relatively low in height in the third direction Z. Thus, the gain of the respective antennas may decrease due to the reduction in the radiation resistance of the respective antennas caused by the reduction in the heights of the respective antennas. Further, with the inner wall of the vehicle on the lower side of the roof 2 being close to the respective antennas, the sensitivity of the respective antennas may decrease due to the floating capacity between the respective antennas and the inner wall. Furthermore, the directivities of the respective antennas may be affected by shielding or reflection of radio waves from the inner wall. Taking into consideration the influence of the inner wall, it is possible to increase the sizes of the AM capacitively loaded element 210, the FM capacitively loaded element 310, and the DAB capacitively loaded element 410 in the directions of the XY plane. However, the peak gain may not always become sufficiently high only by increasing the size of each of the capacitively loaded elements in the directions of the XY plane. Thus, for example, with the use of the inverted-F antenna structure or the tip short antenna structure, it is possible to increase the radiation resistance of the antenna, thereby being able to further improve the peak gain.

In specific, the FM antenna 300 which supports the FM frequency band can increase the radiation resistance of the antenna by using the tip short antenna structure, thereby being able to further improve the peak gain. Further, the DAB antenna 400 which supports the DAB frequency band can increase the radiation resistance of the antenna by using the inverted-F antenna structure, thereby being able to further improve the peak gain.

From the results illustrated in FIG. 7, it can be seen that sufficient sensitivity can be obtained in the FM frequency band even with the tip short antenna structure and without the inverted-L antenna structure. Accordingly, the FM antenna 300 may have the tip short antenna structure instead of the inverted-L antenna structure. In the inverted-L antenna structure, the size and number of turns of each of the three coils used in the inverted-L antenna structure is individually adjusted. Accordingly, when the coils are held on bobbins, the sizes of the bobbins used for the coils may be different. In contrast, in the tip short antenna structure, the sizes and numbers of turns of the feeding-side coil and the short-circuit-side coil can be made the same, thereby being able to make the sizes the same between the feeding-side bobbin and the short-circuit-side bobbin. Accordingly, when the FM antenna 300 has the tip short antenna structure, it is possible to reduce the costs of the FM antenna 300 as compared with the case where the FM antenna 300 has the inverted-L antenna structure.

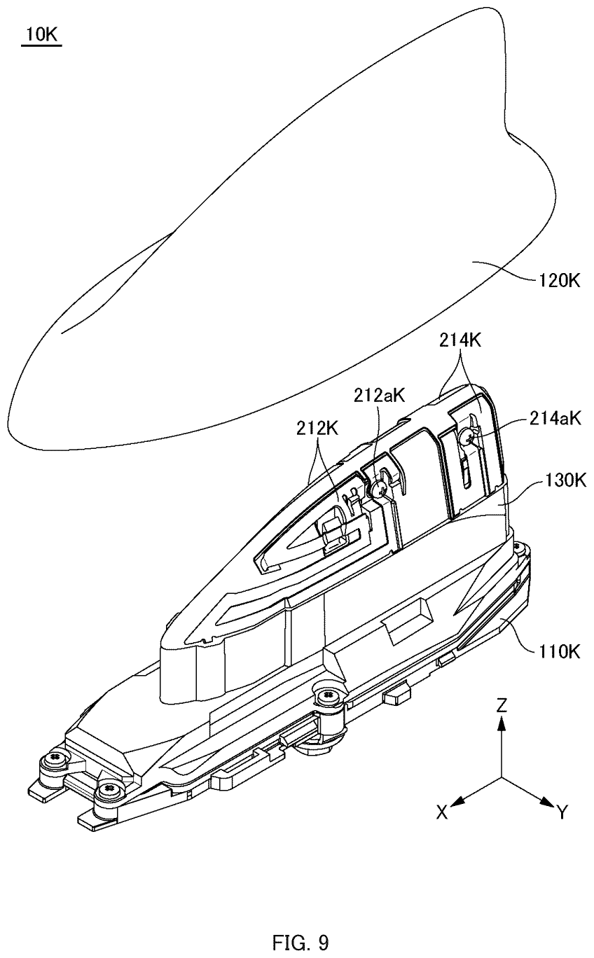

FIG. 9 is a perspective view of an antenna device 10K according to a comparative example.

The antenna device 10K according to the comparative example includes a base 110K, an outer case 120K, an inner case 130K, a pair of front capacitively loaded elements 212K, and a pair of rear capacitively loaded elements 214K.

The base 110K is arranged on the upper side of the roof of the vehicle on the positive direction side of the third direction Z. The outer case 120K is made of a resin having radio wave transparency. The outer case 120K is fastened to the base 110K by snap fitting or the like. The outer case 120K covers the inner case 130K, the pair of front capacitively loaded elements 212K, and the pair of rear capacitively loaded elements 214K from above on the positive direction side of the third direction Z. Accordingly, the base 110K and the outer case 120K form an accommodation space to accommodate the inner case 130K, the pair of front capacitively loaded elements 212K, and the pair of rear capacitively loaded elements 214K. The inner case 130K is arranged on the top surface side of the base 110K in the positive direction of the third direction Z.

The pair of front capacitively loaded elements 212K is arranged along a recess formed in the outer wall of the inner case 130K. Accordingly, the front capacitively loaded elements 212K of a pair are arranged at the position spaced apart from and above, on the positive direction side of the third direction Z, the top surface of the base 110K on the positive direction side of the third direction Z. Each of the front capacitively loaded elements 212K extends in a meandering manner. Portions of the pair of front capacitively loaded elements 212K are attached to the outer wall of the inner case 130K with a front screw 212aK. The pair of front capacitively loaded elements 212K corresponds to the capacitively loaded element of an FM antenna.

The pair of rear capacitively loaded elements 214K is arranged along the groove formed in the outer wall of the inner case 130K. Accordingly, the pair of rear capacitively loaded elements 214K is arranged at the position spaced apart from and above, on the positive direction side of the third direction Z, the top surface of the base 110K on the positive direction side of the third direction Z. Each of the rear capacity loading elements 214K extends in a meandering manner. Portions of the pair of rear capacitively loaded elements 214K are attached to the outer wall of the inner case 130K with a rear screw 214aK. The pair of rear capacitively loaded elements 214K corresponds the capacitively loaded element of a DAB antenna.

The reversed-L antenna structure is arranged in the accommodation space inside the outer case 120K. The pair of front capacitively loaded elements 212K is electrically connected to a helical element (not illustrated) arranged at the accommodation space inside the inner case 130K through the front screw 212aK, thereby forming the reversed-L antenna structure. Similarly, the pair of rear capacitively loaded elements 214K is electrically connected to a helical element (not illustrated) arranged at the accommodation space inside the inner case 130K through the rear screw 214aK, thereby forming the inverted-L antenna structure.

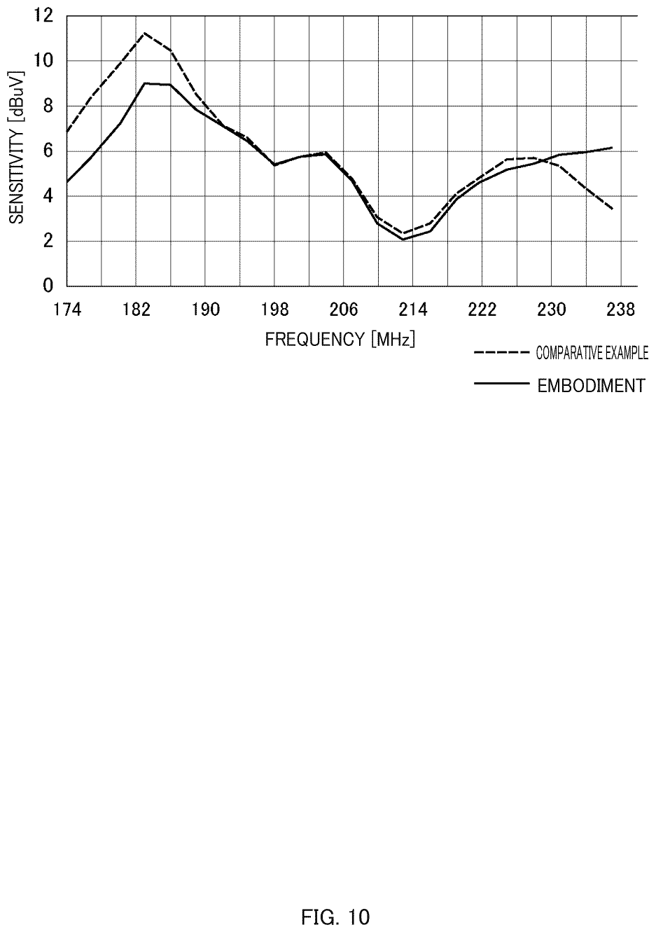

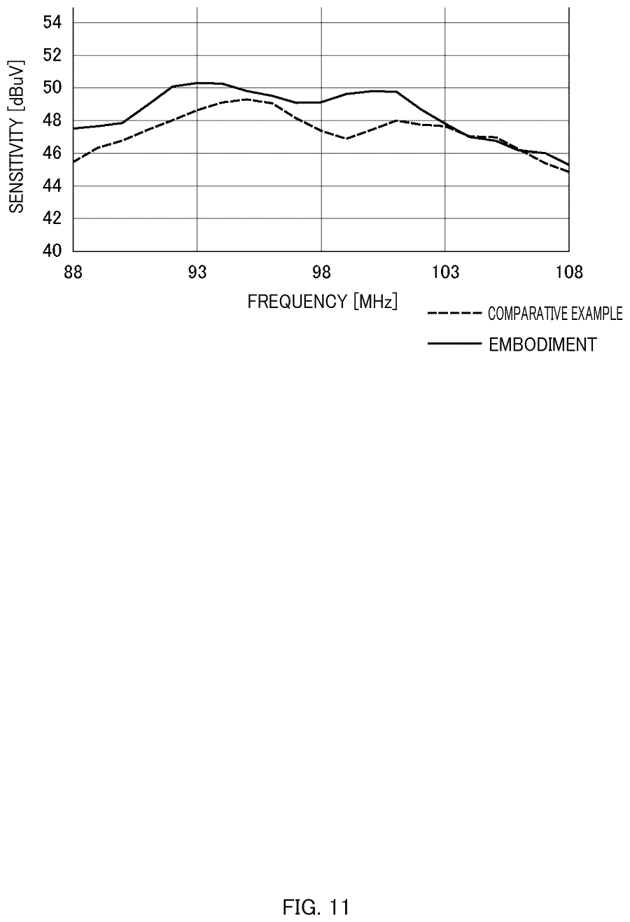

FIG. 10 is a graph illustrating the frequency characteristics of sensitivity in the DAB frequency band of the DAB antenna 400 according to an embodiment of the present disclosure and the antenna device 10K according to the comparative example. FIG. 11 is a graph illustrating the frequency characteristics of sensitivity in the FM frequency band of the FM antenna 300 according to an embodiment of the present disclosure and the antenna device 10K according to the comparative example. The horizontal axes of the graphs illustrated in FIGS. 10 and 11 represent frequency (unit: MHz). The vertical axes of the graphs illustrated in FIGS. 10 and 11 represent sensitivity (unit: dBuV).

In FIGS. 10 and 11, the case 120 according to an embodiment of the present disclosure has a size of 78 mm in the first direction X, 316 mm in the second direction Y, and 32.6 mm in the third direction Z. In FIGS. 10 and 11, the outer case 120K according to the comparative example has a size of 195 mm in the first direction X, 65.6 mm in the second direction Y, and 63 mm in the third direction Z.

In FIGS. 10 and 11, the DAB antenna 400 according to an embodiment of the present disclosure has the inverted-F antenna structure. The FM antenna 300 according to an embodiment of the present disclosure has the tip short antenna structure.

As illustrated in FIG. 10, the sensitivity (e.g., reception level and reception strength, hereinafter the same) of the antenna device 10 according to an embodiment of the present disclosure in the DAB frequency band is substantially the same as the minimum sensitivity of the antenna device 10K according to the comparative example in the DAB frequency band. As illustrated in FIG. 11, the sensitivity of the antenna device 10 according to an embodiment of the present disclosure in the FM frequency band is substantially the same as the minimum sensitivity of the antenna device 10K according to the comparative example in the FM frequency band. Accordingly, it can be seen that the FM antenna 300 and the DAB antenna 400 can achieve the minimum sensitivity as in the antenna device 10K of the comparative example, by appropriately adjusting the respective sizes in the directions of the XY plane of the FM capacitively loaded element 310 and the DAB capacitively loaded element 410 and the antenna structures of the FM antenna 300 and the DAB antenna 400, and thus have characteristics without issues when used.

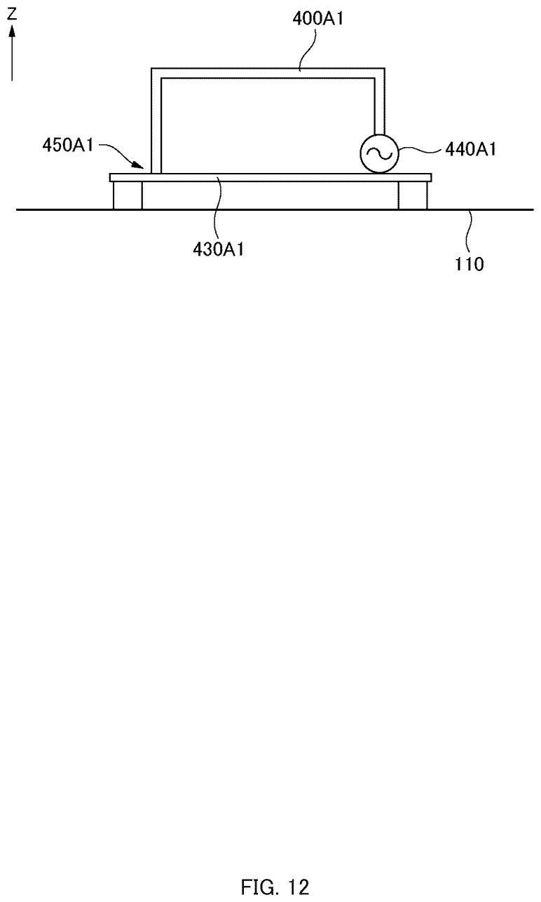

FIG. 12 is a diagram schematically illustrating a DAB feeding portion 440A1 and a DAB short-circuit portion 450A1 of DAB antenna 400A1 according to an example of an embodiment of the present disclosure. The matters described about the DAB antenna 400A1 with reference to FIG. 12 can similarly apply to the AM antenna 200 and the FM antenna 300.

In the example illustrated in FIG. 12, the DAB feeding portion 440A1 and the DAB short-circuit portion 450A1 are arranged at a DAB amplifier substrate 430A1. Accordingly, the manufacturing of the DAB antenna 400A1 and the DAB amplifier substrate 430A1 and the manufacturing of the base 110 can be performed independently of each other. This facilitates the assembling of the base 110, the DAB feeding portion 440A1, and the DAB amplifier substrate 430A1.

At least one of the feeding portion or the short-circuit portion of each of the AM antenna 200, the FM antenna 300 and the DAB antenna 400 may be provided with a filter to prevent interference with other antennas. For example, at least one of the feeding portion or the short-circuit portion of the FM antenna 300 may be provided with a filter, such as a filter to block the AM frequency band, a bandpass filter allowing the FM frequency band to pass therethrough, or the like. The filter can ensure isolation between the AM antenna 200 and the FM antenna 300. Accordingly, it is possible to suppress reduction in gain due to the interference between the AM antenna 200 and the FM antenna 300. Furthermore, even if the distance between the AM antenna 200 and the FM antenna 300 is reduced, it is possible to suppress the reduction in gain due to the interference between the AM antenna 200 and the FM antenna 300.

At least one of the feeding portion or the short-circuit portion of each of the AM antenna 200, the FM antenna 300 and the DAB antenna 400 may be provided with a shortened coil. The shortened coil may be operated as a trap coil for an antenna other than the antenna where the shortened coil is disposed.

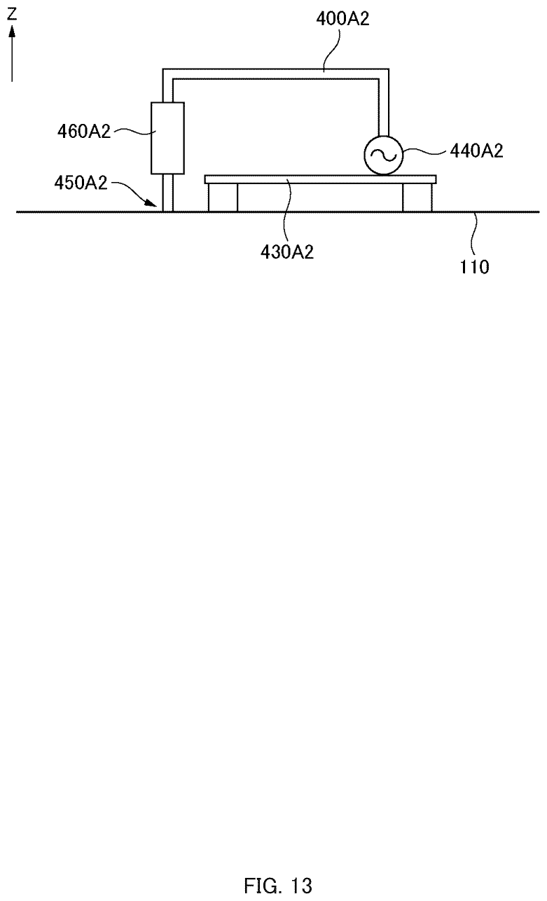

FIG. 13 is a diagram schematically illustrating a DAB feeding portion 440A2 and a DAB short-circuit portion 450A2 of a DAB antenna 400A2 according to another example of an embodiment of the present disclosure.

In the example illustrated in FIG. 13, the DAB feeding portion 440A2 is arranged at a DAB amplifier substrate 430A2. In contrast, the DAB short-circuit portion 450A2 is arranged at the base 110, which is electrically connected to the ground. The DAB short-circuit portion 450A2 can be electrically connected to the base 110 through a screw, soldering, a connecting member such as a leaf spring and the like. In the example illustrated in FIG. 13, there is no need to place the DAB short-circuit portion 450A2 at the DAB amplifier substrate 430A2. Thus, the size of the DAB amplifier substrate 430A2 in the directions of the XY plane can be reduced by an amount corresponding to the DAB short-circuit portion 450A2 not being arranged thereat. Further, with a reduction in the size of the DAB amplifier substrate 430A2 in the directions of the XY plane, the height of the DAB antenna 400A2 in the third direction Z can be ensured. Furthermore, as compared with the case where the DAB short-circuit portion 450A2 is electrically connected to the ground through the DAB amplifier substrate 430A2, it is possible to reduce the conductor loss, thereby being able to improve the ground performance.

In the example illustrated in FIG. 13, an electronic device 460A2 is arranged between the DAB antenna 400A2 and the DAB short-circuit portion 450A2. The electronic device 460A2 is, for example, a tuning coil, a filter, and the like. The electronic device 460A2 can be arranged in the space secured with the reduction in the size of the DAB amplifier substrate 430A2 in the directions of the XY plane. In the space secured with the reduction in the size of the DAB amplifier substrate 430A2 in the direction of the XY plane, a holder for holding the DAB antenna 400A2 may be arranged instead of or in addition to the electronic device 460A2.

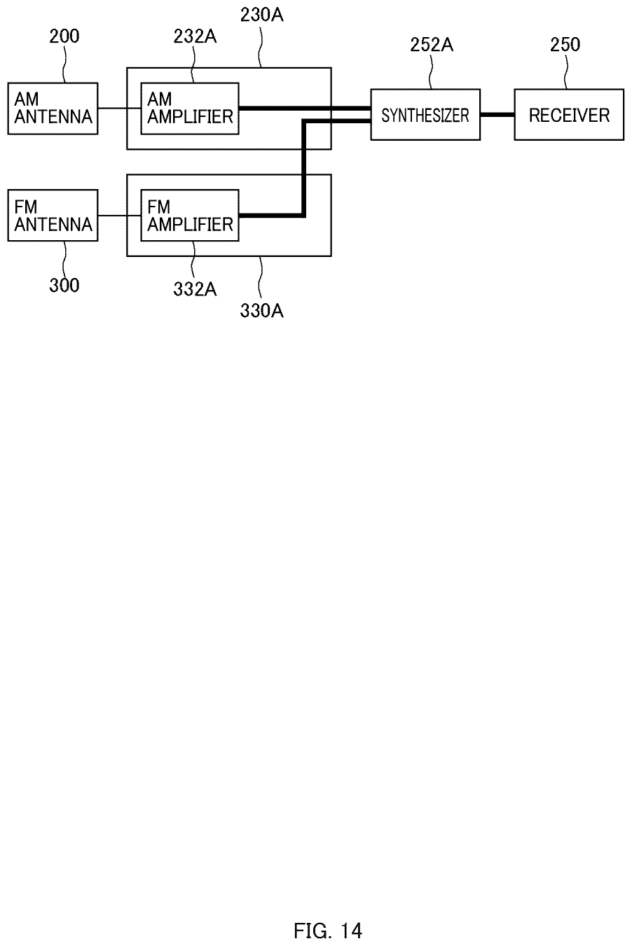

FIG. 14 is a circuit diagram illustrating a first example of the configuration from the AM antenna 200 and the FM antenna 300 to a receiver 250.

The AM antenna 200 is electrically connected to an AM amplifier 232A arranged at an AM amplifier substrate 230A. The FM antenna 300 is electrically connected to an FM amplifier 332A arranged at an FM amplifier substrate 330A. The AM amplifier 232A is electrically connected to a synthesizer 252A through a connection line such as a coaxial cable. The FM amplifier 332A is electrically connected to the synthesizer 252A through a connection line such as a coaxial cable. The synthesizer 252A synthesizes the input from the AM amplifier 232A and the input signal from the FM amplifier 332A. The signal obtained by synthesizing by the synthesizer 252A is inputted to the receiver 250.

In the example illustrated in FIG. 14, there are two output ports: the output port of the AM antenna 200 and the output port of the FM antenna 300. In contrast, the receiver 250 has only one input port. In the example illustrated in FIG. 14, the input signal from the AM antenna 200 and the input signal from the FM antenna 300 are synthesized by the synthesizer 252A. Accordingly, these two output ports of the AM antenna 200 and the FM antenna 300 can be compatible with the one input port of the receiver 250.

In the example illustrated in FIG. 14, the AM antenna 200 and the FM antenna 300 have separate bodies. If the AM antenna 200 and the FM antenna 300 are configured as an integrated AM/FM antenna, the sensitivity of the center frequency in the FM frequency band may not be sufficient, even if sufficient gain is obtained in the AM frequency band. In contrast, in the example illustrated in FIG. 14, the AM antenna 200 and the FM antenna 300 can be adjusted independently of each other. For example, even if the height of the AM antenna 200 in the third direction Z is relatively low, the gain of the AM antenna 200 can be ensured, with the size of the AM capacitively loaded element 210 in the direction of the XY plane being made relatively large. Accordingly, the enhancement of the sensitivity of the center frequency in the FM frequency band is facilitated, as compared with the case where the AM antenna 200 and the FM antenna 300 are configured as an integrated AM/FM antenna.

Further, if the AM antenna 200 and the FM antenna 300 are configured as an integrated AM/FM antenna, the signals from the AM/FM antenna need to be split into an AM signal and an FM signal by a splitter and transmitted to the AM amplifier 232A and the FM amplifier 332A. However, in this case, a loss may occur due to the splitting the signals into the AM signal and the FM signal. In contrast, in the example illustrated in FIG. 14, there is no need to split the signals into the AM signal and the FM signal. Thus, it is possible to suppress the loss caused by splitting the signals into the AM signal and the FM signal.

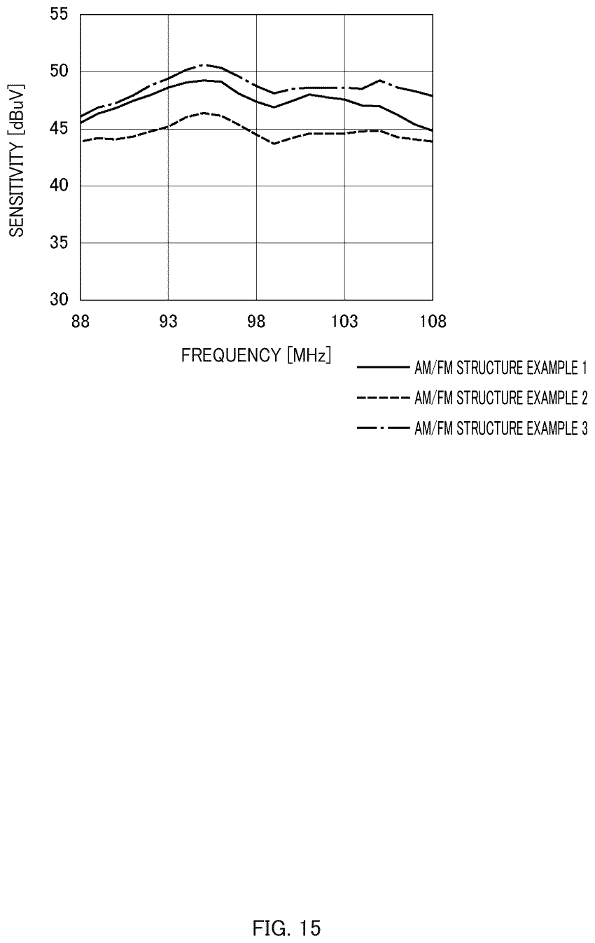

Various AM/FM structure examples will be described with reference to FIG. 15. FIG. 15 is a graph illustrating the frequency characteristics of the sensitivity in the FM frequency band of the AM antenna 200 and the FM antenna 300 according to AM/FM Structure Example 1, AM/FM Structure Example 2, and AM/FM Structure Example 3. The horizontal axis of the graph illustrated in FIG. 15 represents frequency (unit: MHz). The vertical axis of the graph illustrated in FIG. 15 represents sensitivity (unit: dBuV).

In AM/FM Structure Example 1, the AM antenna 200 and the FM antenna 300 have separate bodies and are arranged on the lower side of the roof 2 (on the inner side of the vehicle). In AM/FM Structure Example 2, the AM antenna 200 and the FM antenna 300 are integrated and arranged on the lower side of the roof 2 (on the inner side of the vehicle). In AM/FM Structure Example 3, the AM antenna 200 and the FM antenna 300 are integrated and arranged on the upper side of the roof 2.

As illustrated in FIG. 15, the sensitivity of AM/FM Structure Example 2 in the FM frequency band is lower than the sensitivity of AM/FM Structure Example 3 in the FM frequency band. Accordingly, the sensitivity of the FM frequency band in the case where the AM antenna 200 and the FM antenna 300 are integrated is lower when the AM antenna 200 and the FM antenna 300 are arranged on the lower side of the roof 2 (on the inner side of the vehicle) than when the AM antenna 200 and the FM antenna 300 are arranged on the upper side of the roof 2. However, as illustrated in FIG. 15, the sensitivity of AM/FM Structure Example 1 in the FM frequency band is substantially the same as the minimum sensitivity of AM/FM Structure Example 3 in the FM frequency band. Accordingly, it can be seen that even if the AM antenna 200 and the FM antenna 300 are arranged on the lower side of the roof 2 (on inner side of the vehicle), the reduction in the sensitivity in the FM frequency band can be reduced, with the AM antenna 200 and the FM antenna 300 having separate bodies.

Referring again to FIG. 14, a description will be given to the first example of the configuration from the AM antenna 200 and the FM antenna 300 to the receiver 250.

In the example illustrated in FIG. 14, the AM amplifier substrate 230A and the FM amplifier substrate 330A have separate bodies. Thus, the ground of the AM amplifier substrate 230A is different from the ground of the FM amplifier substrate 330A. In this case, as compared with the case where the AM amplifier substrate 230A and the FM amplifier substrate 330A are integrated and the ground of the AM amplifier substrate 230A is the same as the ground of the FM amplifier substrate 330A, it is possible to suppress mutual interference such as noise effects, electrical coupling between the AM amplifier substrate 230A and the FM amplifier substrate 330A. Accordingly, as compared with the case where the AM amplifier substrate 230A and the FM amplifier substrate 330A are integrated, it is possible to reduce the size of the AM amplifier substrate 230A and the FM amplifier substrate 330A in the directions of the XY plane, thereby being able to reduce the costs of the AM amplifier substrate 230A and the FM amplifier substrate 330A.

In the example illustrated in FIG. 14, even if the distance between the AM amplifier substrate 230A and the FM amplifier substrate 330A is increased in order to reduce the mutual interference between the AM antenna 200 and the FM antenna 300, the AM antenna 200 is arranged at the AM amplifier substrate 230A and the FM antenna 300 is arranged at the FM amplifier substrate 330A. Accordingly, it is possible to increase the distance between the AM amplifier substrate 230A and the FM amplifier substrate 330A, while the sizes of the AM amplifier substrate 230A and the FM amplifier substrate 330A in the direction of the XY plane are being kept small.

In the example illustrated in FIG. 14, the AM antenna product package of the AM antenna 200 and the AM amplifier substrate 230A is separate from the FM antenna product package of the FM antenna 300 and the FM amplifier substrate 330A. When the AM antenna 200 and the FM antenna 300 are integrated as an AM/FM antenna, the AM frequency band sometimes does not need to be used. Even in this case, it is possible to operate the AM/FM antenna only as an FM antenna. However, in this case, an AM amplifier that is not used is mounted, which leads to an increase in costs. Further, even when the AM amplifier is not installed, an identifier such as a marker or the like to classify products is needed in the manufacturing process, which leads to an increase in costs of quality control. In contrast thereto, in the example illustrated in FIG. 14, if the use of the AM frequency band is not needed, it is possible to refrain from mounting the AM antenna product package of the AM antenna 200 and the AM amplifier substrate 230A. Accordingly, as compared with the case where the AM antenna 200 and the FM antenna 300 is integrated as an AM/FM antenna, the classification of products is facilitated, thereby being able to reduce the cost of quality control, which makes it possible to reduce the production costs of the antenna device itself.

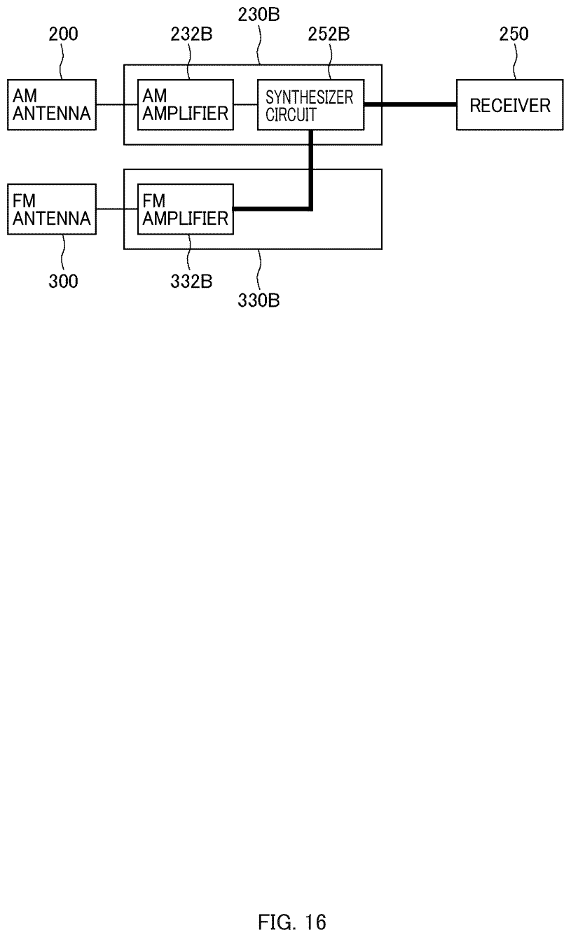

FIG. 16 is a circuit diagram illustrating a second example of the configuration from the AM antenna 200 and the FM antenna 300 to the receiver 250. The second example illustrated in FIG. 16 is the same as the first example illustrated in FIG. 14 except for the following points.

Both an AM amplifier 232B and a synthesizer circuit 252B are arranged at an AM amplifier substrate 230B. An FM amplifier 332B is arranged at an FM amplifier substrate 330B. The FM amplifier 332B is electrically connected to the synthesizer circuit 252B of the AM amplifier substrate 230B through a connection line such as a coaxial cable or the like.

In the example illustrated in FIG. 16, there is no need to connect the AM amplifier 232B and the synthesizer circuit 252B through a coaxial cable. Accordingly, as compared with the case where the synthesizer circuit 252B is arranged outside the AM amplifier substrate 230B, the number of coaxial cables can be reduced. Thus, as compared with the case where the synthesizer circuit 252B is arranged outside the AM amplifier substrate 230B, it is possible to improve the degree of freedom in the layout in the vehicle, and achieve the reduction in weight and costs of the antenna device 10.

Examples of a connector to be connected to the coaxial cable include a multi-pole connector. When the multi-pole connector is used, it is possible to reduce the size and costs of the connector, as compared with the case where a single-pole connector is used.

In the example illustrated in FIG. 16, the synthesizer circuit 252B is arranged at the AM amplifier substrate 230B. However, the synthesizer circuit 252B may be arranged at the FM amplifier substrate 330B instead of the AM amplifier substrate 230B. In this case as well, it is possible to reduce the number of coaxial cables, as compared with the case where the synthesizer circuit 252B is arranged outside the FM amplifier substrate 330B.

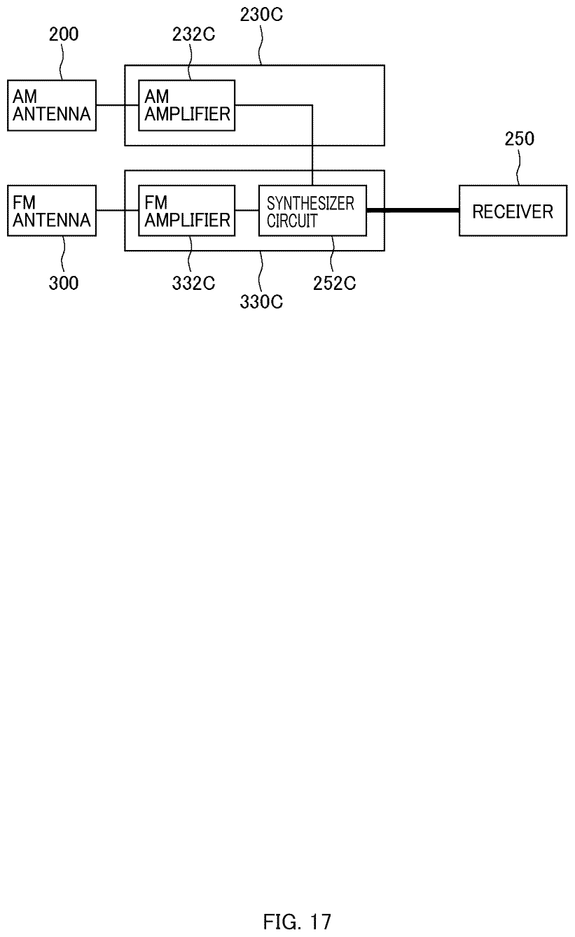

FIG. 17 is a circuit diagram illustrating a third example of the configuration from the AM antenna 200 and the FM antenna 300 to the receiver 250.

An FM amplifier 332C and a synthesizer circuit 252C are arranged at an FM amplifier substrate 330C. An AM amplifier 232C is arranged at an AM amplifier substrate 230C. The AM amplifier 232C is electrically connected to the synthesizer circuit 252C. In the example illustrated in FIG. 17, the AM amplifier 232C and the synthesizer circuit 252C can be electrically connected through an AV line (low-voltage line for vehicles) instead of the coaxial cable. Accordingly, as compared with the case where the coaxial cable is used, the costs of the antenna device 10 can be reduced. Unlike the FM amplifier 332C, the Impedance matching using coaxial cables with impedances such as 50Ω, 75Ω, and the like is less important in the AM amplifier 232C. In the AM amplifier 232C, the voltage division loss is more important than the impedance matching. It is possible to reduce losses more in the case where the AM amplifier 232C and the synthesizer circuit 252C are connected through the AV line, than in the case where the AM amplifier 232C and the synthesizer circuit 252C are connected through the coaxial cable.

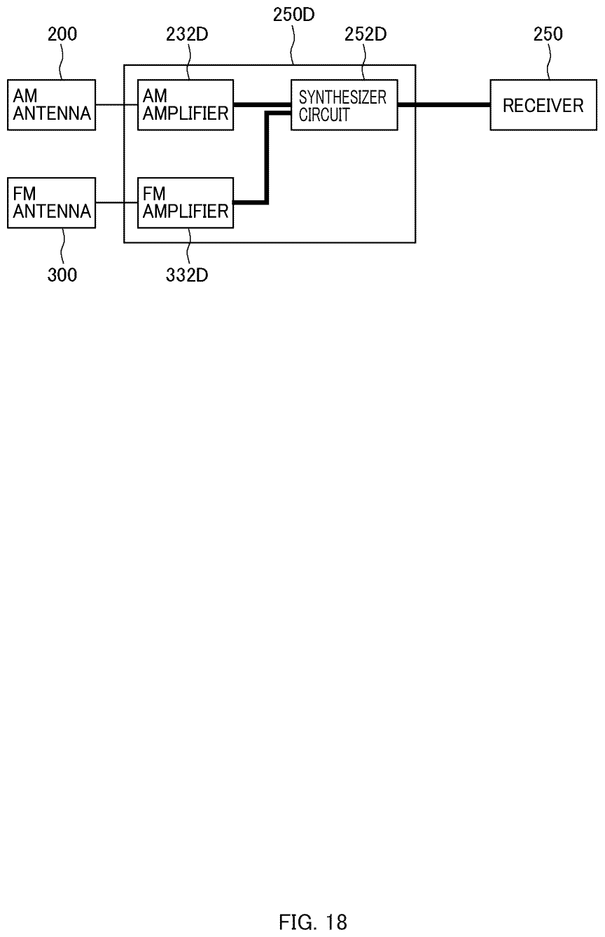

FIG. 18 is a circuit diagram illustrating a fourth example of the configuration from the AM antenna 200 and the FM antenna 300 to the receiver 250.

An AM amplifier 232D, an FM amplifier 332D, and a synthesizer circuit 252D are arranged at the same amplifier substrate 250D. The AM amplifier 232D and the FM amplifier 332D are electrically connected to the synthesizer circuit 252D through connection lines such as coaxial cables.

In the example illustrated in FIG. 18, it is possible to miniaturize the amplifier substrate 250D, as compared with the case where the AM amplifier substrate and the FM amplifier substrate have separate bodies. Further, it is possible to miniaturize the amplifier substrate 250D, as compared with the case where the synthesizer and the AM amplifier substrate or FM amplifier substrate have separate bodies.

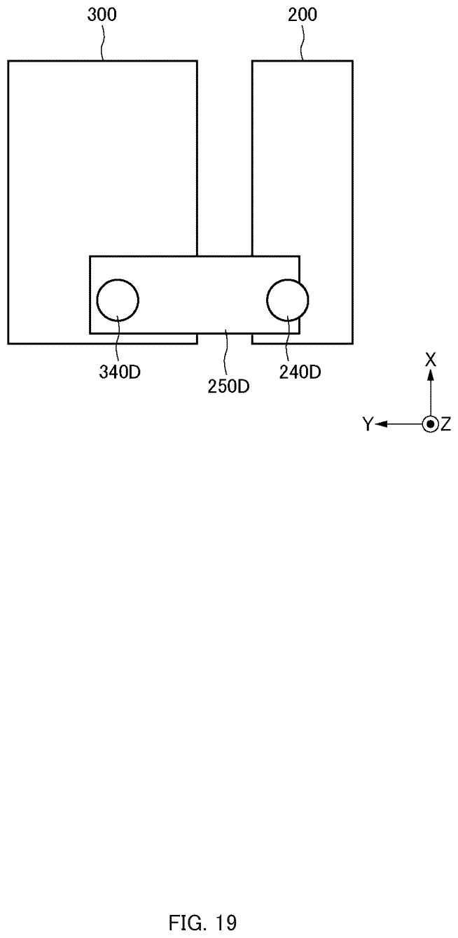

FIG. 19 is a top view of the AM antenna 200 and the FM antenna 300 illustrated in FIG. 18.

In the example illustrated in FIG. 19, when seen from the third direction Z, the AM feeding portion 240D is arranged at the right end part of the amplifier substrate 250D in the negative direction of the second direction Y. When seen from the third direction Z, the FM feeding portion 340D is arranged at the left end part of the amplifier substrate 250D in the positive direction of the second direction Y. Accordingly, it is possible to secure isolation between the AM amplifier 232D and the FM amplifier 332D by securing the distance between the AM feeding portion 240D and the amplifier substrate 250D, as compared with the case where the AM feeding portion 240D is arranged at the amplifier substrate 250D on the right side in the positive direction of the second direction Y with respect to the right end part in the negative direction of the second direction Y, or the case where the FM feeding portion 340D is arranged at the amplifier substrate 250D on the left side in the negative direction of the second direction Y with respect to the left end part in the positive direction of the second direction Y.

In the DAB antenna 400 illustrated in FIG. 3 described above, the DAB amplifier substrate 430 is fixed to the base 110, which acts as a ground portion, with a conductive screw. This makes it possible to electrically connect the ground pattern of the DAB amplifier substrate 430 to the ground portion (here, the roof 2 and the base 110). Similarly, as illustrated in FIG. 2, the AM amplifier substrate 230 and the FM amplifier substrate 330 are each screwed to the base 110 with a conductive screw, thereby electrically connecting them to the ground portion. However, antenna substrates such as the AM amplifier substrate 230, the FM amplifier substrate 330, and the DAB amplifier substrate 430 may be electrically connected to the ground portion in another aspect, as in a first modification described later.

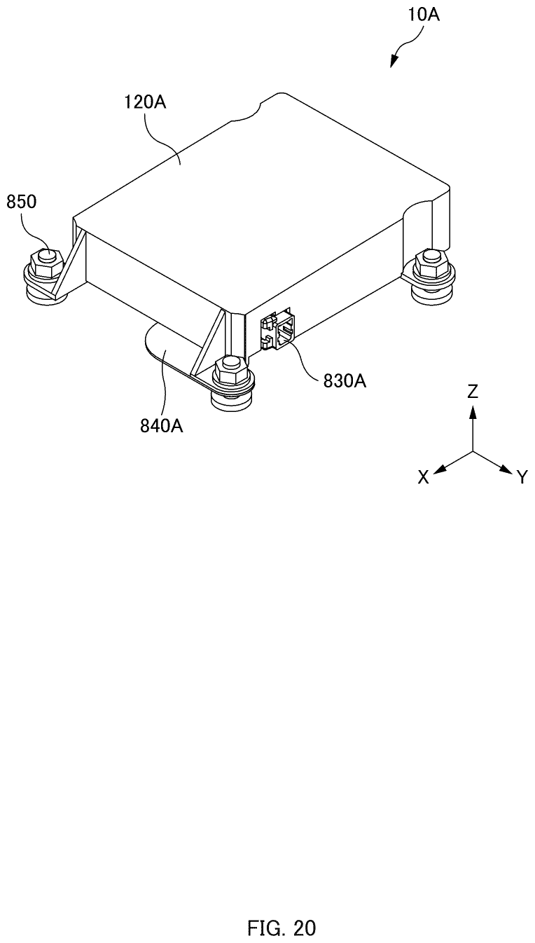

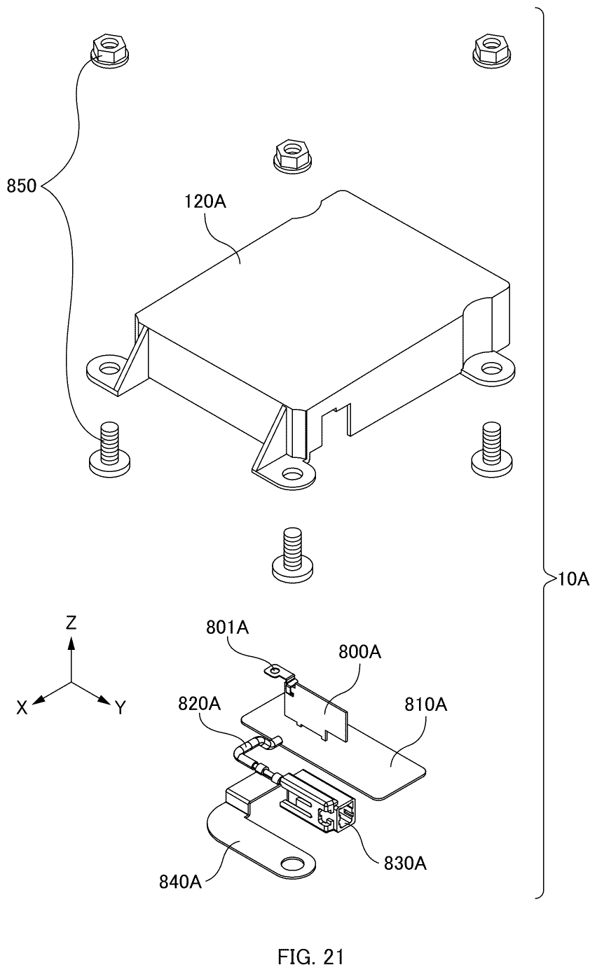

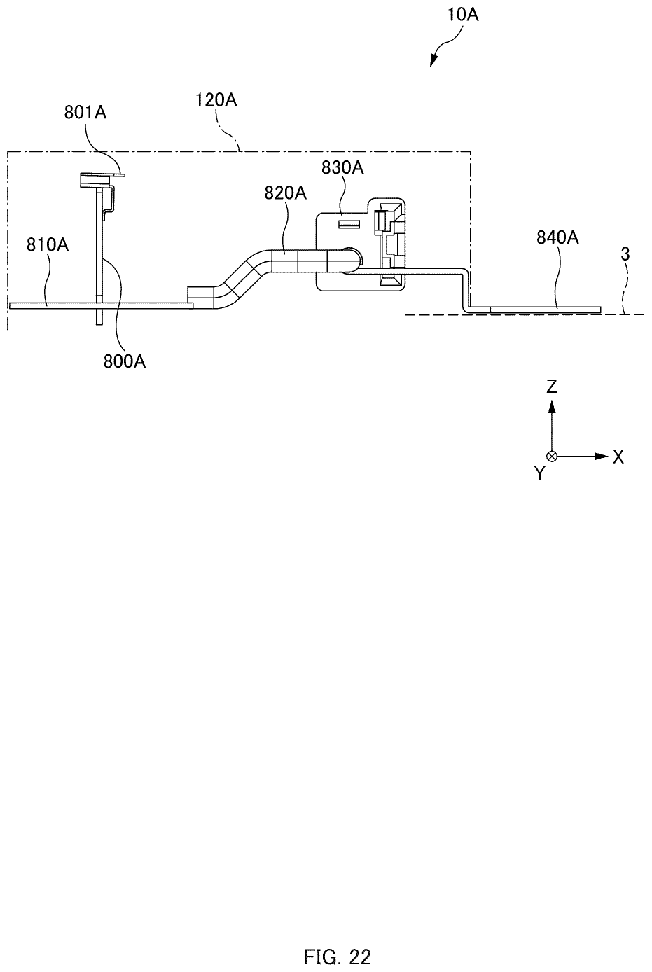

FIG. 20 is a perspective view of an antenna device according to a first modification of an embodiment of the present disclosure. FIG. 21 is an exploded perspective view of the antenna device according to the first modification of the embodiment of the present disclosure. FIG. 22 is a side view of the antenna device according to the first modification of an embodiment of the present disclosure, with the case portion and screws removed.

As illustrated in FIG. 21, an antenna device 10A according to the first modification includes a case 120A, an antenna 800A, an antenna substrate 810A, a coaxial cable 820A, and a ground connection portion 840A.

The case 120A is made of a resin having radio wave transparency, or the like, and has a substantially rectangular parallelepiped shape, as with the case 120 of the antenna device 10 illustrated in FIG. 2 described above. However, the shape of the case 120A is not limited to this example. The case 120A covers the antenna 800A, the antenna substrate 810A, the coaxial cable 820A, and the ground connection portion 840A from above on the positive direction side of the third direction Z. The case 120A forms a predetermined accommodation space. The antenna 800A, the antenna substrate 810A, the coaxial cable 820A, and the ground connection portion 840A are housed inside the predetermined accommodation space.

The case 120A is fixed to the predetermined part of the vehicle (not illustrated) with screws 850, as illustrated in FIGS. 20 and 21. The case 120A may be fixed to the predetermined part of the vehicle through a base plate, or may be fixed to the predetermined part of the vehicle (for example, the roof 2 illustrated in FIG. 1).

The antenna 800A is arranged on the upper surface side of the antenna substrate 810A in the positive direction of the third direction Z. The antenna 800A corresponds to the AM antenna 200, the FM antenna 300, or the DAB antenna 400 of the antenna device 10 illustrated in FIG. 2 described above. However, FIGS. 21 and 22 illustrate the antenna 800A in which only the helical element portion (corresponding to, for example, the DAB helical element 420 in the antenna device 10) is illustrated, without illustrating the capacitively loaded element portion (corresponding to, for example, the AM capacitively loaded element 210, the FM capacitively loaded element 310, and the DAB capacitively loaded element 410, in the antenna device 10).

As illustrated in FIG. 21, the antenna 800A (specifically, the helical element portion) has a substantially rectangular shape with a pair of long sides substantially parallel to the second direction Y and a pair of short sides substantially parallel to the third direction Z. However, the shape of the antenna 800A is not limited to this example.

In the antenna 800A, a support portion 801A is formed at the end part on the negative direction side of the second direction Y on the positive direction side of the third direction Z. The support portion 801A is a portion to support the capacitively loaded element portion (not illustrated) of the antenna 800A. The antenna 800A (specifically, the helical element portion) is held by case 120A through this capacitively loaded element portion.

The antenna substrate 810A is a plate-shaped member where a conductor pattern is formed, and corresponds to the AM amplifier substrate 230, the FM amplifier substrate 330, or the DAB amplifier substrate 430 of the antenna device 10 illustrated in FIG. 2 described above. As illustrated in FIG. 21, the antenna substrate 810A has a substantially rectangular shape with a pair of long sides substantially parallel to the second direction Y and a pair of short sides substantially parallel to the first direction X. However, the shape of the antenna substrate 810A is not limited to this example. As illustrated in FIG. 22, the antenna substrate 810A is held by the case 120A and is positioned above and spaced apart by a predetermined distance from the predetermined part of the vehicle to which the case 120A is fixed.

The coaxial cable 820A is a cable member to transmit signals between the antenna substrate 810A and an external module such as a controller. The coaxial cable 820A is a flexible cable member, and includes a signal line that is an inner conductor and a ground line that is an outer conductor. The signal line is formed of, for example, a copper wire, and is a part through which signals are transmitted. The ground line is formed, for example, of an AV line or braid, and is a grounded part. The coaxial cable 820A further includes an insulating portion disposed between the signal line and the ground line, and an outer coating that covers the signal line, the ground line, and the insulating portion. As illustrated in FIG. 21, a connector 830A is formed at the end art of the coaxial cable 820A on the side opposite to the antenna substrate 810A. The connector 830A is configured such that the cable connected to the above-described external module can be insertable thereto and removable therefrom.

The ground connection portion 840A is a conductive member for connecting the antenna substrate 810A to the ground portion 3. Here, the ground portion 3 may be the roof 2 or a separate ground member connected to the roof 2.

One end of the ground connection portion 840A is connected to the ground line of the coaxial cable 820A. In specific, the outer coating of the coaxial cable 820A is removed such that the ground line is exposed, and then the ground line and the above one end of the ground connection portion 840A are crimped together, thereby connecting the one end of the ground connection portion 840A with the ground line of the coaxial cable 820A. The other end of the ground connection portion 840A is positioned on and in contact with the ground portion 3, as illustrated in FIG. 22, and is fixed to the predetermined part of the vehicle (not illustrated) together with the case 120A with the screws 850, as illustrated in FIG. 20.

When the ground portion 3 is the roof 2, the other end part of the ground connection portion 840A can be connected to the ground member without going through the base 110 of the antenna device 10 described above. Accordingly, with the base 110 being omitted or miniaturized, the antenna device 10A can be further miniaturized.

The coaxial cable 820A is a cable member having flexibility as described above, and the one end of the ground connection portion 840A is connected to such a cable member having flexibility. Thus, the ground connection portion 840A can be arranged in a flexible manner, without limiting the positional relationship between the ground connection portion 840A and the antenna 800A and antenna substrate 810A, to that in the example illustrated in FIG. 21.

An aspect for connecting the antenna substrate to the ground portion is not limited to the example of the antenna device 10A of the first modification, as in a second modification, which will be described later, the antenna substrate may be connected to the ground portion in other aspects.

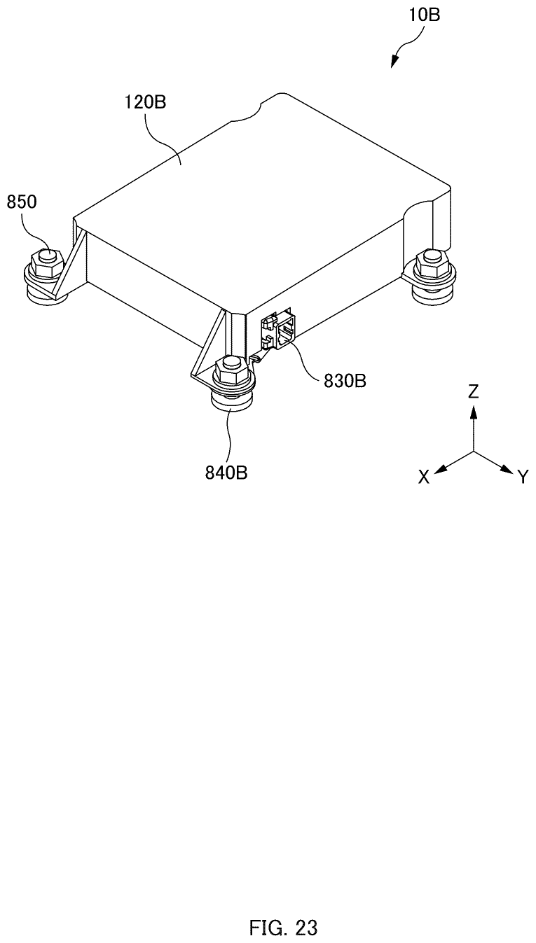

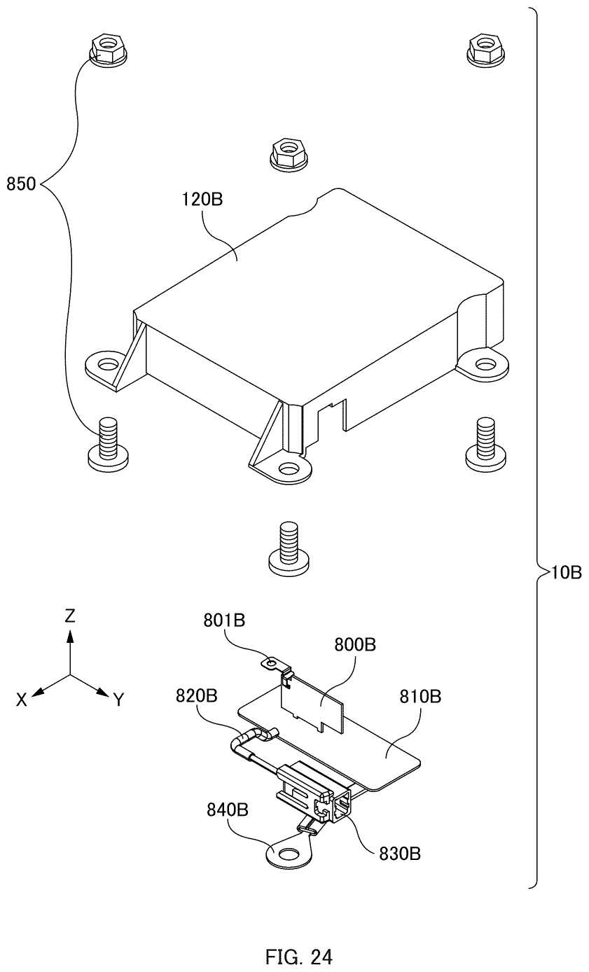

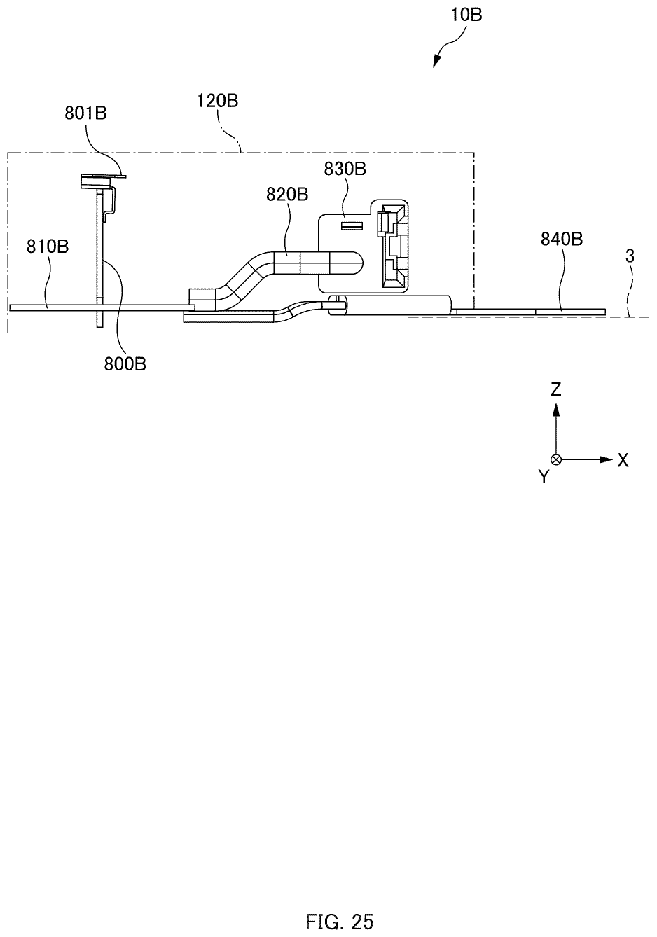

FIG. 23 is a perspective view of an antenna device according to the second modification of an embodiment of the present disclosure. FIG. 24 is an exploded perspective view of an antenna device according to the second modification of an embodiment of present disclosure. FIG. 25 is a side view of an antenna device according to the second modification of an embodiment of the present disclosure, with the case portion and screws removed.

The antenna device 10B according to the second modification includes a case 120B, an antenna 800B, an antenna substrate 810B, a coaxial cable 820B having a connector 830B formed at an end part thereof, and a ground connection portion 840B.

The case 120B, the antenna 800B, the antenna substrate 810B, and the coaxial cable 820B are the same as or similar to the case 120A, the antenna 800A, the antenna substrate 810A, and the coaxial cable 820A of the antenna device 10A described above. However, in the antenna device 10B, the arrangement and shape of the ground connection portion 840B are different from those of the ground connection portion 840A of the antenna device 10A.

The ground connection portion 840B is a conductive member for connecting the antenna substrate 810B to the ground portion 3. Unlike the above-described ground connection portion 840A, one end of the ground connection portion 840B is connected to the antenna substrate 810B, without being connected to the ground line of the coaxial cable 820A. The other end of the ground connection portion 840B is positioned on and in contact with the ground portion 3, as illustrated in FIG. 25, and is fixed, together with the case 120B, to the predetermined part of the vehicle (not illustrated) with the screws 850, as illustrated in FIG. 23.

When the ground portion 3 is the roof 2, the other end of the ground connection portion 840B can be connected to the ground member without going through the base 110 of the antenna device 10 described above. Accordingly, with the base 110 being omitted or miniaturized, the antenna device 10B can be further miniaturized.

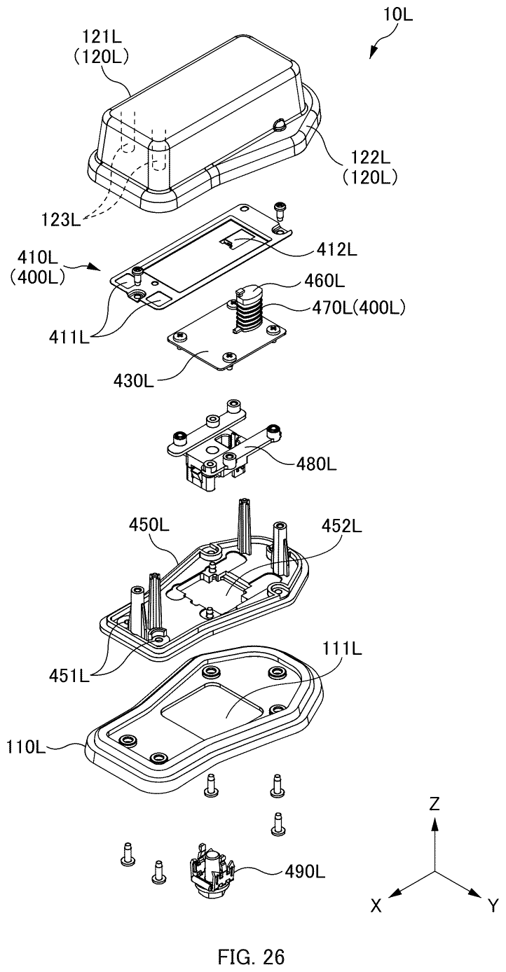

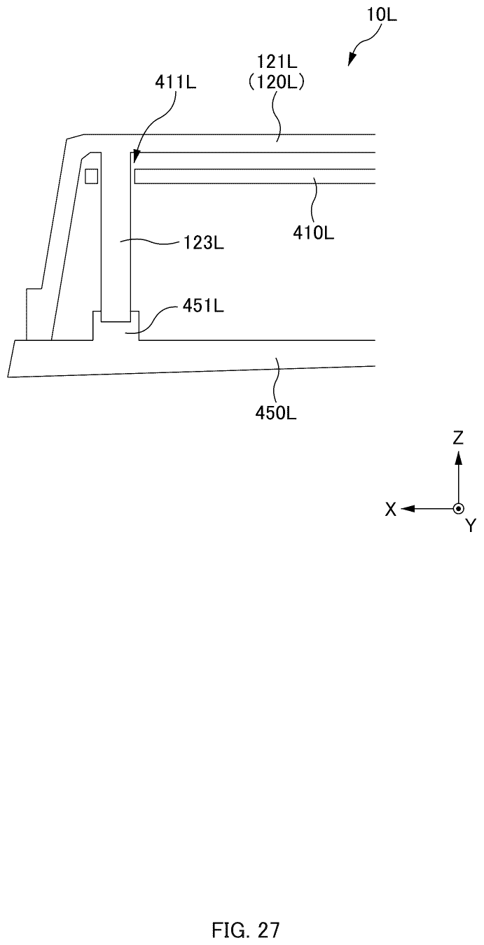

FIG. 26 is an exploded perspective view of an antenna device according to a third modification of an embodiment of the present disclosure. FIG. 27 is an explanatory diagram illustrating a cross section of the configuration of a part of the antenna device according to the third modification.

As illustrated in FIG. 26, an antenna device 10L according to the third modification includes a case 120L, an antenna 400L, a substrate 430L, a metal base 480L, a resin base 450L, a pad 110L, and a capture 490L.

The case 120L is a member to accommodate the antenna 400L and the substrate 430L therein. The case 120L is made of a resin having radio wave transparency, or the like. The case 120L includes an upper case portion 121L and a lower case portion 122L.

The upper case portion 121L has a substantially rectangular parallelepiped shape, and as illustrated in FIGS. 26 and 27, a pair of bosses 123L is formed on the inner side of the upper case portion 121L. The pair of bosses 123L are separately formed so as to be aligned in the second direction Y on the inner side of the upper case portion 121L, and each of the pair of bosses 123L is formed so as to extend in the third direction Z. Each of the pair of bosses 123L is inserted into an opening 411L formed in a capacitively loaded element 410L of the antenna 400L, as will be described later. Then, the tip of each of the pair of bosses 123L is abutted against a fixing portion 451L formed at the resin base 450L on the side in the positive direction of the third direction Z, and is fixed, together with the pad 110L, from the negative direction side of the third direction Z of the pad 110L. Accordingly, the case 120L is supported by the resin base 450L and the pad 110L.

The lower case portion 122L is located on the negative direction side of the third direction Z with respect to the upper case portion 121L, and has an outer circumference larger than that of the upper case portion 121L when seen in the third direction Z. The outer periphery of the lower case portion 122L has substantially the same size and shape as the outer periphery of the pad 110L.

The antenna 400L is an FM antenna having an inverted-L antenna structure. However, the antenna 400L included in the antenna device 10L is not limited to the inverted-L antenna structure, but may be the inverted-F antenna structure illustrated in FIG. 4 described above, the tip short antenna structure illustrated in FIG. 5 described above, or any other antenna structures. Further, the antenna 400L included in the antenna device 10L is not limited to the FM antenna, but may be the AM antenna, the DAB antenna, or other antennas. The matters described about the inverted-L antenna structure of the antenna 400L with reference to FIGS. 26 and 27 can similarly apply to the AM antenna, the DAB antenna, and other antennas.

The antenna 400L includes the capacitively loaded element 410L and a coil 470L.

The capacitively loaded element 410L has a substantially rectangular shape with a pair of long sides substantially parallel to the first direction X and a pair of short sides substantially parallel to the second direction Y. However, the shape of the capacitively loaded element 410L is not limited to this example. The capacitively loaded element 410L can have various shapes such as a strip, a circle, a polygon, a three-dimensional structure, a meander, and the like. The opening 411L is formed in the capacitively loaded element 410L. The opening 411L is an opening through which the boss 123L described above is to be inserted.

If the boss 123L is not configured to be inserted into the opening 411L formed in the capacitively loaded element 410L (i.e., if the opening 411L is not formed in the capacitively loaded element 410L), the boss 123L needs to be positioned outside the capacitively loaded element 410L when seen in the third direction Z to avoid interference with the capacitively loaded element 410L. In such a case, the case 120L (by extension, the entire antenna device 10L) increases in size by an amount corresponding to the boss 123L being positioned outside the capacitively loaded element 410L. Then, if the size of the shape of the outer edge in the capacitively loaded element 410L is reduced such that the capacitively loaded element 410L will fit between the pair of bosses, in order to suppress the increase in the size of the entire antenna device 10L, then, this affects the characteristics of the antenna 400L that has been determined by the shape of the outer edge of the capacitively loaded element 410L.

Thus, in an antenna device 10L according to the third modification, as illustrated in FIG. 27, the opening 411L is formed in the capacitively loaded element 410L, and the boss 123L is inserted into the opening 411L. This suppresses the increase in the size of the entire antenna device 10L, while suppressing the interference between the capacitively loaded element 410L and the boss 123L. In other words, it is possible to maximize the size of the shape of the outer edge of the capacitively loaded element 410L while suppressing the increase in the size of the entire antenna device 10L (i.e., it is possible to suppress the effect on the characteristics of the antenna device 10L caused by the reduction in the size of the outer edge of the capacitively loaded element 410L). Here, when the antenna 400L is in operation, the current flowing through the capacitively loaded element 410L is distributed mainly along the outer edge of the capacitively loaded element 410L, and thus the effect on the characteristics of the antenna 400L caused by the opening 411L being formed in the capacitively loaded element 410L is suppressed.

The coil 470L is formed by winding onto a bobbin 460L. In the antenna device 10L according to the third modification, the bobbin 460L is connected to the surface of the substrate 430L on the positive direction side of the third direction Z. The lower end of the coil 470L on the negative direction side of the third direction Z is electrically connected to the feeding portion (not illustrated) arranged at the substrate 430L. The upper end of the coil 470L on the positive direction side of the third direction is electrically connected to the element connection portion 412L of the capacitively loaded element 410L.

The substrate 430L is an antenna substrate where the feeding portion and the ground pattern of the antenna 400L are arranged. The substrate 430L is supported by being screwed to the metal base 480L.

The metal base 480L is a member made of a conductor and is located at the substrate 430L on the negative direction side of the third direction Z. The metal base 480L supports the substrate 430L as described above, and is electrically connected to the ground pattern of the substrate 430L. As will be described below, the metal base 480L is electrically connected to the ground portion (for example, the metal part of the roof in the vehicle) by the capture 490L.

The resin base 450L is a member made of a resin, and supports the antenna 400L and the substrate 430L as described above. The resin base 450L includes, on the positive direction side of the third direction Z, the fixing portion 451L against which the tip end of each of the above-described pair of bosses 123L abuts. The above-described metal base 480L and the resin base 450L may be collectively referred to as antenna base.

The pad 110L is a member to prevent water from entering the interiors of the vehicle and the antenna device 10L.

The capture 490L is a member to electrically connect the metal base 480L and the ground portion of the antenna device 10L (for example, the metal part of the roof in the vehicle). In the state in which the antenna device 10L is installed, the capture 490L is connected to the metal base 480L through the opening 111L of the pad 110L and the opening 452L of the resin base 450L.

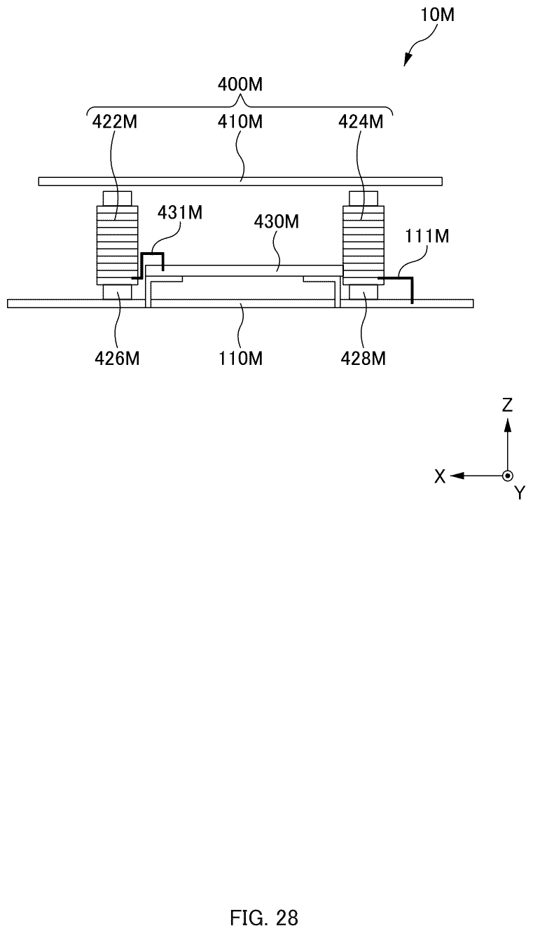

FIG. 28 is an explanatory diagram of an antenna device according to a fourth modification of an embodiment of the present disclosure.

In the antenna device 10L according to the third modification described above, the bobbin 460L on which the coil 470L is formed by winding is connected onto the substrate 430L. However, as in the antenna device 10M according to the fourth modification, the lower ends of the bobbins (a feeding-side bobbin 426M and a short-circuit-side bobbin 428M described later) may be connected to the base bobbin 110M. This makes it possible to achieve the lower height of the antenna device 10M as compared with the case where the lower ends of the bobbins are connected onto the substrate.

Here, the antenna 400M included in the antenna device 10M is an FM antenna having the tip short antenna structure illustrated in FIG. 5 described above. The antenna 400M includes an FM capacitively loaded element 410M that is the same as the FM capacitively loaded element 410B illustrated in FIG. 5 described above, a feeding-side coil 422M formed by winding on the feeding-side bobbin 426M, and a short-circuit-side coil 424M formed by winding on the short-circuit-side bobbin 428M. Further, in order to support the AM frequency band as well, a capacitor and/or an LC series resonant circuit adjusted for the FM frequency band may be interposed in series between the short-circuit-side coil 424M and the short-circuit portion (ground), or between the short-circuit-side coil 424M and the FM capacitively loaded element 410B, such that the antenna supports the AM frequency band.

However, the antenna 400M included in the antenna device 10M is not limited to the tip short antenna structure, but may have the inverted-F antenna structure illustrated in FIG. 4 described above, the inverted-L antenna structure illustrated in FIG. 6 described above, or other antenna structures. Further, the antenna 400M included in the antenna device 10M is not limited to an FM antenna, but may be the AM antenna, the DAB antenna, or other antennas. The matters described about the tip short antenna structure of the antenna 400M with reference to FIG. 28 can similarly apply to the DAB antenna and other antennas.

In the antenna device 10M according to the fourth modification, as illustrated in FIG. 28, the feeding-side coil 422M formed by winding on the feeding-side bobbin 426M is connected to the feeding portion (not illustrated) of the substrate 430M by the feeding connection portion 431M, and the short-circuit-side coil 424M formed by winding on the short-circuit-side bobbin 428M is connected to a base 110M by the ground connection portion 111M. However, the short-circuit-side coil 424M formed by winding on the short-circuit-side bobbin 428M may be connected to the ground pattern (not illustrated) of the substrate 430M.

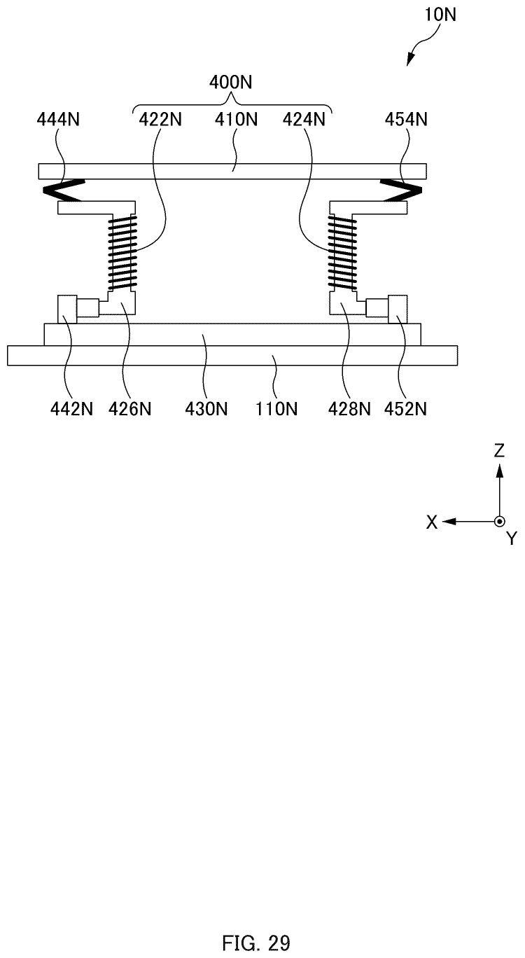

FIG. 29 is an explanatory diagram of an antenna device according to a fifth modification of an embodiment of the present disclosure.

In the FM antenna 400B having the tip short antenna structure illustrated in FIG. 5, the upper end of the feeding-side coil 422B on the positive direction side of the third direction Z is electrically connected to the feeding-side connection portion 444B arranged at the end part of the FM capacitively loaded element 410B on the positive direction side of the first direction X. Further, the upper end of the short-circuit-side coil 424B on the positive direction side of the third direction Z is electrically connected to the short-circuit-side connection portion 454B arranged at the end part of the FM capacitively loaded element 410B on the negative direction side of the first direction X.

An antenna 400N included in an antenna device 10N according to the fifth modification is an FM antenna having the tip short antenna structure, as in the FM antenna 400B illustrated in FIG. 5 described above. The antenna 400N includes an FM capacitively loaded element 410N, a feeding-side coil 422N formed by winding on a feeding-side bobbin 426N, and a short-circuit-side coil 424N formed by winding on a short-circuit-side bobbin 428N. In the antenna device 10N according to the fifth modification, a feeding-side connection portion 444N and a short-circuit-side connection portion 454N may be formed of a metal leaf spring. This makes it possible to improve the degree of freedom in the assembly procedure of the antenna device 10N while securing the electrical contact between the feeding-side coil 422N and the FM capacitively loaded element 410N, and the electrical contact between the short-circuit-side coil 424N and the FM capacitively loaded element 410N.

In specific, in the antenna device 10N according to the fifth modification, a substrate 430N having a base 110N at which the feeding portion 442N and the short-circuit portion 452N are arranged, the feeding-side bobbin 426N on which the feeding-side coil 422N is formed by winding, the short-circuit-side bobbin 428N on which the short-circuit-side coil 424N is formed by winding, and leaf springs (the feeding-side connection portion 444N and the short-circuit-side connection portion 454N) are assembled in advance. Further, installing of the FM capacitively loaded element 410N from above (the positive direction side of the third direction Z) can easily achieve the electrical contact between the feeding-side coil 422N and the FM capacitively loaded element 410N, and the electrical contact between the short-circuit-side coil 424N and the FM capacitively loaded element 410N.

Embodiments and modification examples of the present disclosure have been described above with reference to the drawings, but they are just examples of the present disclosure, and various configurations other than those described above may be employed.

According to the present Description, an antenna and an antenna device of Aspects described below are provided.

### Aspect 1

Aspect 1 is the antenna that supports the DAB frequency band, the antenna including: the DAB capacitively loaded element 410A, the upper coil 422A having the upper end on the positive direction side of the third direction Z connected to the DAB capacitively loaded element 410A; a feeding-side lower coil 424A having the upper end on the positive direction side of the third direction Z connected to the lower end of the upper coil 422A on the negative direction side of the third direction Z, and having the lower end on the negative direction side of the third direction Z connected to the DAB feeding portion 440A; and the short-circuit-side lower coil 426A having the upper end on the positive direction side of the third direction Z connected to the lower end of the upper coil 422A on the negative direction side of the third direction Z, and having the lower end on the negative direction side of the third direction Z connected to the ground portion

A “first capacitively loaded element” corresponds to the “DAB capacitively loaded element 410A” in Aspect described above. A “first coil” corresponds to the “upper coil 422A” in Aspect described above. A “second coil” corresponds to the “feeding-side lower coil 424A” in Aspect described above. A “third coil” corresponds to the “short-circuit-side lower coil 426A” in Aspect described above.

“One end” of the first coil corresponds to the “upper end on the positive direction side of the third direction Z” of the upper coil 422A in Aspect described above. “Another end” of the first coil corresponds to the “lower end on the negative direction side of the third direction Z” of the upper coil 422A in Aspect described above. “One end” of the second coil corresponds to the “upper end on the positive direction side of the third direction Z” of the feeding-side lower coil 424A in Aspect described above. “Another end” of the second coil corresponds to the “lower end on the negative direction side of the third direction Z” of the feeding-side lower coil 424A in Aspect described above. “One end” of the third coil corresponds to the “upper end” of the short-circuit-side lower coil 426A “on the positive direction side of the third direction Z” in Aspect described above. “Another end” of the third coil corresponds to the “lower end on the negative direction side of the third direction Z” of the short-circuit-side lower coil 426A in Aspect described above.

A “feeding portion” corresponds to the “DAB feeding portion 440A” in Aspect described above.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 2

In Aspect 2, the inductance of the feeding-side lower coil 424A is larger than the inductance of the upper coil 422A, and the inductance of the short-circuit-side lower coil 426A is larger than the inductance of the feeding-side lower coil 424A.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 3

Aspect 3 is the antenna that supports the FM frequency band, the antenna including the FM capacitively loaded element 410B, the feeding-side coil 422B having the upper end on the positive direction side of the third direction Z connected to the FM capacitively loaded element 410B, and having the lower end on the negative direction side of the third direction Z connected to the FM feeding portion 442B; and the short-circuit-side coil 424B having the upper end on the positive direction side of the third direction Z connected to the FM capacitively loaded element 410B, and having the lower end on the negative direction side of the third direction Z connected to the ground portion.

A “second capacitively loaded element” corresponds to the “FM capacitively loaded element 410B” in Aspect described above. A “fourth coil” corresponds to the “feeding-side coil 422B” in Aspect described above. A “fifth coil” corresponds to the “short-circuit-side coil 424B” in Aspect described above.

“One end” of the fourth coil corresponds to the “upper end on the positive direction side of the third direction Z” of the feeding-side coil 422B in Aspect described above. “Another end” of the fourth coil corresponds to the “lower end on the negative direction side of the third direction Z” of the feeding-side coil 422B in Aspect described above. “One end” of the fifth coil corresponds to the “upper end on the positive direction side of the third direction Z” of the short-circuit-side coil 424B in Aspect described above. “Another end” of the fifth coil corresponds to the “lower end on the negative direction side of the third direction Z” of the short-circuit-side coil 424B in Aspect described above.

A “feeding portion” corresponds to the “FM feeding portion 442B” in Aspect described above

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 4

In Aspect 4, the short-circuit coil 424B is arranged at a distance from the center of the FM capacitively loaded element 410B on the side opposite to the side on which the feeding-side coil 422B is arranged.

According to Aspect described above, it is possible to reduce the height of the antenna constituting the antenna device 10, thereby being able to suppress the reduction in the gain of the antenna.

### Aspect 5

In Aspect 5, the antenna according to Aspect 1 or 2 and the base 110 are included, wherein each of the upper coil 422A, the feeding-side lower coil 424A, and the short-circuit-side lower coil 426A is arranged between the DAB capacitively loaded element 410A and the base 110.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 6

In Aspect 6, the base 110 is the ground portion.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 7

In Aspect 7, the base 110 and the FM amplifier substrate 430B arranged at the front surface of the base 110 are included, wherein the lower end of the feeding-side coil 422B on the negative direction side of the third direction Z is located at the first position of the FM amplifier substrate 430C, and the lower end of the short-circuit-side coil 424B on the negative direction side of the third direction Z is located at the second position of the FM amplifier substrate 430B. Further, the FM capacitively loaded element 410B is formed such that the length thereof in the second direction Y intersecting the first direction X is longer than the length thereof in the first direction X in a top view, and the first position and the second position are located to be aligned in the first direction X at the FM amplifier substrate 430B.

A “substrate” corresponds to the “FM Amplifier substrate 430B” in Aspect described above.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### Aspect 8

Aspect 8 is the antenna device 10 that supports the DAB frequency band and the FM frequency band, and includes the base 110, and the DAB capacitively loaded element 410A and the FM capacitively loaded element 410B that face the base 110. The antenna device further includes the upper coil 422A, the feeding-side lower coil 424A, and the short-circuit-side lower coil 426A that are arranged between the base 110 and the DAB capacitively loaded element 410A, and the feeding-side coil 422B and the short-circuit-side coil 424B that are arranged between the base 110 and the FM capacitively loaded element 410B. Further, the upper end of the upper coil 422A on the positive direction side of the third direction Z is connected to the DAB capacitively loaded element 410A, the upper end of the feeding-side lower coil 424A on the positive direction side of the third direction Z is connected to the lower end of the upper coil 422A on the negative direction side of the third direction Z, the lower end of the feeding-side lower coil 424A on the negative direction side of the third direction Z is connected to the DAB feeding portion 440A, the upper end of the short-circuit-side lower coil 426A on the positive direction side of the third direction Z is connected to the lower end of the upper coil 422A on the negative direction side of the third direction Z, and the lower end of the short-circuit-side lower coil 426A on the negative direction side of the third direction Z is connected to the ground portion. Further, the upper end of the feeding-side coil 422B on the positive direction side of the third direction Z is connected to the FM capacitively loaded element 410B, the lower end of the feeding-side coil 422B on the negative direction side of the third direction Z is connected to the FM feeding portion 442B, the upper end of the short-circuit-side coil 424B on the positive direction side of the third direction Z is connected to the FM capacitively loaded element 410B, and the lower end of the short-circuit-side coil 424B on the negative direction side of the third direction Z is connected to the ground portion.

According to Aspect described above, it is possible to reduce the heights of the FM antenna 300, the DAB antenna 400 and the antenna device 10, thereby being able to suppress the reduction in the gains of the FM antenna 300 and the DAB antenna 400.

### REFERENCE SIGNS LIST

10, 10A, 10B, 10K, 10L, 10M, 10N Antenna device
110, 110K, 110N Base
300, 400B FM antenna
310, 410B FM capacitively loaded element
330, 330A, 330B, 330C, 430B, 430C FM amplifier substrate
340D, 442B FM feeding portion
400, 400A, 400A1, 400A2, 400C DAB antenna
410, 410A, 410C DAB capacitively loaded element
422A Upper coil
422B Feeding-side coil
424A Feeding-side lower coil
424 Short-circuit-side coil
426A Short-circuit-side lower coil
430, 430A1, 430A2 DAB amplifier substrate
440A, 440A1, 440A2, 440C DAB feeding portion

1. An antenna that supports a Digital Audio Broadcasting (DAB) frequency band, the antenna comprising:
a first capacitively loaded element;
a first coil having one end connected to the first capacitively loaded element;
a second coil having one end connected to another end of the first coil, and another end connected to a feeding portion; and
a third coil having one end connected to the other end of the first coil, and another end connected to a ground portion.

2. The antenna according to claim 1, wherein
an inductance of the second coil is larger than an inductance of the first coil, and
an inductance of the third coil is larger than the inductance of the second coil.

3. An antenna that supports a Frequency Modulation (FM) frequency band, the antenna comprising:
a second capacitively loaded element;
a fourth coil having one end connected to the second capacitively loaded element, and another end connected to a feeding portion; and
a fifth coil having one end connected to the second capacitively loaded element, and another end connected to a ground portion.

4. The antenna according to claim 3, wherein the fifth coil is arranged at a distance from a center of the second capacitively loaded element on a side opposite to a side on which the fourth coil is arranged.

5. An antenna device, comprising:
the antenna according to claim 1; and
a base, wherein
each of the first coil, the second coil, and the third coil is arranged between the first capacitively loaded element and the base.

6. The antenna device according to claim 5, wherein the base is a ground portion.

7. An antenna device, comprising:
the antenna according to claim 3;
a base; and
a substrate arranged at a front surface of the base, wherein
the other end of the fourth coil is located at a first position of the substrate,
the other end of the fifth coil is located at a second position of the substrate,
the second capacitively loaded element has a length in a first direction and a length in a second direction, and is formed such that the length in the second direction intersecting the first direction is longer than the length in the first direction, in a top view, and
the first position and the second position are located to be aligned in the first direction at the substrate.

8. An antenna device that supports a Digital Audio Broadcasting (DAB) frequency band and a Frequency Modulation (FM) frequency band, the antenna comprising:
a base;
a first capacitively loaded element and a second capacitively loaded element that face the base;
a first coil, a second coil, and a third coil that are arranged between the base and the first capacitively loaded element; and
a fourth coil and a fifth coil that are arranged between the base and the second capacitively loaded element, wherein
the first coil has one end connected to the first capacitively loaded element,
the second coil has one end connected to another end of the first coil, and another end connected to a feeding portion,
the third coil has one end connected to the other end of the first coil, and another end connected to a ground portion,
the fourth coil has one end connected to the second capacitively loaded element, and another end connected to a feeding portion, and
the fifth coil has one end connected to the second capacitively loaded element, and another end connected to the ground portion.
